(19) United States
(12) Patent Application Publication
(10) Pub. No.: US 2023/0147363 A1
(43) Pub. Date: May 11, 2023

(54) TONER, TONER STORING UNIT, AND IMAGE FORMING APPARATUS

(71) Applicants: Ryuuta YOSHIDA, Shizuoka (JP); Akio TAKEI, Shizuoka (JP); Ryohei YAMAGUCHI, Shizuoka (JP); Toma TAKEBAYASHI, Shizuoka (JP)

(72) Inventors: Ryuuta YOSHIDA, Shizuoka (JP); Akio TAKEI, Shizuoka (JP); Ryohei YAMAGUCHI, Shizuoka (JP); Toma TAKEBAYASHI, Shizuoka (JP)

(21) Appl. No.: 17/982,521

(22) Filed: Nov. 8, 2022

(30) Foreign Application Priority Data
Nov. 10, 2021 (JP) 2021-183408

(51) Int. Cl. G03G 9/08; G03G 9/087

(52) U.S. Cl. CPC G03G 9/0825; G03G 9/08755; G03G 9/0806; G03G 9/0821; G03G 9/0827

(57) ABSTRACT

A toner includes: toner base particles each containing a binder resin; and resin particles on a surface of each of the toner base particles. A glass transition temperature (Tg) of the toner at the first heating in differential scanning calorimetry (DSC) is 20° C. or higher and 50° C. or lower. A glass transition temperature of a tetrahydrofuran (THF)-insoluble component of the toner at the first heating in DSC is −40° C. or higher and 10° C. or lower. An average circularity of the toner is 0.970 or more and 0.985 or less. A standard deviation of the average circularity is 0.020 or less.

### CROSS-REFERENCE TO RELATED APPLICATION

The present application claims priority under 35 U.S.C. § 119 to Japanese Patent Application No. 2021-183408, filed Nov. 10, 2021. The contents of which are incorporated herein by reference in their entirety.

### BACKGROUND OF THE INVENTION

### 1. Field of the Invention

The disclosures herein generally relate to a toner, a toner storing unit, and an image forming apparatus.

### 2. Description of the Related Art

In recent years, a toner desirably has a smaller particle diameter and hot-offset resistance for outputting images of higher quality, low-temperature fixability for energy savings, and enough heat-resistant storage stability to endure high-temperature, high-humidity conditions during storage and transportation after the production thereof. Of these, improvement of the toner in low-temperature fixability is particularly desired because the power consumed at the time of fixation accounts for much of the power consumed in the image forming process.

In order to improve the low-temperature fixability of the toner, a low-melting-point material is used in the toner. However, the toner produced using the low-melting-point material has poor heat-resistant storage stability. There is a trade-off relationship between low-temperature fixability and heat-resistant storage stability.

A traditionally used toner is produced by the kneading and pulverizing method. The kneading and pulverizing method, however, has difficulty producing a toner having a smaller particle diameter. In addition, the shape of the toner produced thereby is amorphous, and the particle size distribution thereof is broad. Thus, the toner produced by the kneading and pulverizing method fails to produce an image having enough quality, and requires high energy for being fixed. Also, when wax (release agent) is added during production of the toner produced by the kneading and pulverizing method for improvement in fixability thereof, the toner cracks at the interfaces with the wax during pulverization, exposing a large quantity of the wax on the toner surface. As a result, while the toner exhibits the release effect, the toner is more likely to adhere to a carrier, a photoconductor, and a blade (i.e., filming). The properties of the toner are not satisfactory as a whole.

As a way to improve cleanability, proposed is controlling the shape of a toner to be amorphous rather than spherical to produce the effect of prevent the toner from passing through a cleaning member (see, for example, Japanese Unexamined Patent Application Publication No. 2002-372806).

An object of the present disclosure is to provide a toner that is excellent in low-temperature fixability, heat-resistant storage stability, cleanability, and transferability.

### SUMMARY OF THE INVENTION

In one embodiment, a toner of the present disclosure includes toner base particles each containing a binder resin, and resin particles on a surface of each of the toner base particles. A glass transition temperature of the toner at the first heating in differential scanning calorimetry (DSC) is 20° C. or higher and 50° C. or lower. A glass transition temperature of a tetrahydrofuran (THF)-insoluble component of the toner at the first heating in differential scanning calorimetry (DSC) is −40° C. or higher and 10° C. or lower. An average circularity of the toner is 0.970 or more and 0.985 or less. A standard deviation of the average circularity 0.020 or less.

The present disclosure can provide a toner that is excellent in low-temperature fixability, heat-resistant storage stability, cleanability, and transferability.

### BRIEF DESCRIPTION OF THE DRAWINGS

FIG. 1 is a schematic view illustrating one example of an image forming apparatus according to the present disclosure;

FIG. 2 is a schematic view illustrating one example of a process cartridge; and

FIG. 3 is a view illustrating one example of how resin particles exist on a toner surface in the present disclosure.

### DESCRIPTION OF THE PREFERRED EMBODIMENTS

In the following, embodiments of the present invention will be described with reference to the accompanying drawings.

(Toner)

A toner of the present disclosure includes toner base particles each containing a binder resin, and resin particles on a surface of each of the toner base particles. A glass transition temperature of the toner at the first heating in differential scanning calorimetry (DSC) is 20° C. or higher and 50° C. or lower. A glass transition temperature of a tetrahydrofuran (THF)-insoluble component of the toner at the first heating in differential scanning calorimetry (DSC) is −40° C. or higher and 10° C. or lower. An average circularity of the toner is 0.970 or more and 0.985 or less. A standard deviation of the average circularity is 0.020 or less.

The toner described in Japanese Unexamined Patent Application Publication No. 2002-372806 is made amorphous in the shape thereof as described above. During image formation, however, the above toner is degraded in transferability thereof in a transfer step of transferring an image on an image bearer to a print paper sheet directly or indirectly via an intermediate transfer member.

In view thereof, the present inventors conducted intensive studies and have found that when the glass transition temperature of a toner is 20° C. or higher and 50° C. or lower and the glass transition temperature of the tetrahydrofuran (THF)-insoluble component of the toner is −40° C. or higher and 10° C. or lower, the entire toner particle maintains heat-resistant storage stability, and part of the resin forming the toner is readily deformed even at low temperatures, which can promote adhesion of the toner to a recording medium by application of heat and pressure upon fixation. Also, the present inventors have found that when the average circularity of the toner is 0.970 or more and 0.985 or less and the standard deviation of the average circularity is 0.020 or less, the toner has improved heat-resistant storage stability and cleanability.

<Average Circularity>

The average circularity of the toner of the present disclosure is 0.970 or more and 0.985 or less and preferably 0.975 or more and 0.980 or less. The average circularity indicates the extent of irregularities of the toner surface. When the average circularity is 0.970 or more, resin particles and external additives can be uniformly deposited on the toner surface, leading to improvement in heat-resistant storage stability and transferability. When the average circularity is 0.985 or less, the friction force occurring when the toner particles are rolling becomes higher, and the toner particles are unlikely to pass through a cleaning blade and are excellent in cleanability.

<Standard Deviation of Average Circularity>

The standard deviation of the average circularity of the toner of the present disclosure is 0.020 or less and preferably 0.014 or less. When the standard deviation of the average circularity is 0.020 or less, unevenness of the surface state of each toner particle can be reduced, and the resulting toner is excellent in heat-resistant storage stability and cleanability.

A method of measuring the average circularity and the standard deviation of the average circularity is not particularly limited and may be appropriately selected in accordance with the intended purpose. For example, a flow particle image analyzer (“FPIA-2100”, obtained from Sysmex Corporation) and analysis software (FPIA-2100 Data Processing Program for FPIA version00-10) can be used for the measurement.

Specifically, a 100 mL glass beaker is charged with 0.1 ml or more and 0.5 ml or less of a 10% by mass surfactant (alkyl benzene sulfonate, NEOGEN SC-A, obtained from DKS Co., Ltd.) and with 0.1 g or more and 0.5 g or less of the toner, and the mixture is stirred with a micro spatula. To the mixture, 80 mL of ion-exchanged water is added. The obtained dispersion liquid is dispersed for three minutes with an ultrasonic disperser (obtained from HONDA ELECTRONICS Co., Ltd.). The dispersion liquid is measured for the shape and distribution of the toner with the analysis software FPIA-2100 until the concentration of the toner is from 5,000 particles/μL through 15,000 particles/μL.

In the above measurement method, it is important to adjust the concentration of the dispersion liquid to be from 5,000 particles/μL through 15,000 particles/μL in terms of reproducibility in the measurement of the average circularity.

Similar to the measurement of the toner particle diameter as described above, the required amount of a surfactant is different depending on hydrophobicity of the toner. A large quantity of the surfactant generates noises due to bubbles. A small quantity of the surfactant cannot wet the toner enough for the toner to be dispersed well.

Also, the amount of the toner added is different depending on the particle diameter of the toner. Small-particle-diameter toner particles are required to be added in a small quantity, and large-particle-diameter toner particles are required to be added in a large quantity. When the toner particle diameter is from 3 μm through 10 μm, from 0.1 g through 0.5 g of the toner can be added to adjust the concentration of the dispersion liquid to be from 5,000 particles/μL through 15,000 particles/μL.

The average circularity of the toner and the standard deviation of the average circularity of the toner can be controlled by adjusting, for example, a disc-circumferential speed of a bead mill upon mixing of materials forming the toner or the number of passes through a bead mill per unit volume of the toner when an oil phase is prepared in the production of toner base particles.

<Glass Transition Temperature (Tg)>

The glass transition temperature (Tg) of the toner of the present disclosure as determined from a differential scanning calorimetry (DSC) curve at the first heating in DSC is 20° C. or higher and 50° C. or lower and preferably 40° C. or higher and 50° C. or lower. When the glass transition temperature is 20° C. or higher, the toner does not become readily deformed by application of heat, improving in heat-resistant storage stability. When the glass transition temperature is 50° C. or lower, the toner flows appropriately by application of heat upon fixation, and readily fixes even at low temperatures; i.e., excellent in low-temperature fixability.

The glass transition temperature (Tg) of the THF-insoluble component of the toner of the present disclosure as determined from a differential scanning calorimetry (DSC) curve at the first heating in DSC is −40° C. or higher and 10° C. or lower and preferably −40° C. or higher and 5° C. or lower. When the glass transition temperature is −40° C. or higher, the THF-insoluble component of the toner inhibits the heat-resistant storage stability of the toner to a lesser extent. When the glass transition temperature is 10° C. or lower, part of the resin forming the toner is readily deformed even at low temperatures; i.e., excellent in low-temperature fixability.

The glass transition temperature (Tg) of the THF-soluble component of the toner of the present disclosure as determined from a DSC curve at the first heating in DSC is preferably 20° C. or higher and 65° C. or lower. When the glass transition temperature is 20° C. or higher, excellent heat-resistant storage stability is obtained. When the glass transition temperature is 65° C. or lower, excellent low-temperature fixability is obtained.

A method of measuring the glass transition temperature is not particularly limited and may be appropriately selected in accordance with the intended purpose. For example, the glass transition temperature can be determined from a DSC curve obtained through differential scanning calorimetry (DSC).

Specifically, 1 g of the toner is added to 100 mL of tetrahydrofuran (THF), followed by Soxhlet extraction, to produce a THF-insoluble component and a THF-soluble component from the toner. The THF-insoluble component and the THF-soluble component are dried for 24 hours with a vacuum dryer, to produce a THF-insoluble polyester resin component and a THF-soluble polyester resin component. In the following, the THF-insoluble polyester resin component was used as a sample of interest for the measurement of the glass transition temperature of the THF-insoluble component of the toner, and the THF-soluble polyester resin component was used as a sample of interest for the measurement of the glass transition temperature of the THF-soluble component of the toner. Also, the toner was used as a sample of interest for the measurement of the glass transition temperature of the toner.

Next, 5.0 mg of the sample of interest is put into a sample container of aluminum, and the sample container is placed on a holder unit and set in an electric furnace.

Next, in a nitrogen atmosphere, the sample of interest is heated from −80° C. to 150° C. at a heating rate of 1.0° C./min (the first heating).

Next, the sample of interest is cooled from 150° C. to −80° C. at a cooling rate of 1.0° C./min and then heated from −80° C. to 150° C. at a heating rate of 1.0° C./min (the second heating).

At the first heating and the second heating, DSC curves are measured with a differential scanning calorimeter (Q-200, obtained from TA Instruments). Using the analysis program in the Q-200 system, the glass transition temperature Tg1^{st} at the first heating is determined by selecting the DSC curve at the first heating from the obtained DSC curves. Similarly, the glass transition temperature Tg2^{nd} at the second heating is determined by selecting the DSC curve at the second heating.

The toner of the present disclosure includes toner base particles; and if necessary, may further include other components.

<Toner Base Particles>

The toner base particles (hereinafter may be referred to as “toner bases” or “base particles”) each include a binder resin and preferably include a colorant and wax. If necessary, the toner base particles may each further include other components.

Also, the toner base particles include resin particles on surfaces thereof.

<<Binder Resin>>

The binder resin is not particularly limited and may be appropriately selected in accordance with the intended purpose. Examples of the binder resin include a polyester resin, a styrene-acrylic resin, a polyol resin, vinyl resins, a polyurethane resin, an epoxy resin, a polyamide resin, a polyimide resin, silicon resins, a phenol resin, a melamine resin, a urea resin, an aniline resin, an ionomer resin, and a polycarbonate resin. These may be used alone or in combination. Of these, a polyester resin is preferable because it can impart flexibility to the resulting toner.

<<<Polyester Resin>>>

The polyester resin is not particularly limited and may be appropriately selected in accordance with the intended purpose. Examples of the polyester resin include a crystalline polyester resin, a non-crystalline polyester resin, a modified polyester resin, and a non-crystalline hybrid resin. These may be used alone or in combination.

—Non-Crystalline Polyester Resin—

The non-crystalline polyester resin (hereinafter may be referred to as “non-crystalline polyester”, “amorphous polyester”, “amorphous polyester resin”, “unmodified polyester resin”, or “polyester resin component A”) is not particularly limited and may be appropriately selected in accordance with the intended purpose. Examples of the non-crystalline polyester resin include a non-crystalline polyester resin obtained through reaction between polyol and polycarboxylic acid.

In the present disclosure, the non-crystalline polyester resin refers to a product obtained through reaction between polyol and polycarboxylic acid, as described above. Any product obtained by modifying the polyester resin, such as the below-described prepolymer, or a modified polyester resin obtained through crosslinking and/or elongation reaction of the prepolymer is not included in the non-crystalline polyester resin, but is treated as a modified polyester resin in the present disclosure.

The unmodified polyester resin refers to a polyester resin obtained through reaction between multivalent alcohol and multivalent carboxylic acid (e.g., multivalent carboxylic acid itself, multivalent carboxylic anhydride, and multivalent carboxylic acid ester) or derivatives thereof, where the polyester resin is not modified with, for example, an isocyanate compound.

The non-crystalline polyester is a polyester resin component soluble in tetrahydrofuran (THF).

The non-crystalline polyester (the polyester resin component A) is preferably a linear polyester resin.

Examples of the polyol include diol.

Examples of the diol include: (C2-C3) alkylene oxides adducts of bisphenol A (the average number by mole of the alkylene oxides added: from 1 through 10), such as polyoxypropylene(2.2)-2,2-bis(4-hydroxyphenyl)propane and polyoxyethylene (2.2)-2,2-bis(4-hydroxyphenyl)propane; ethylene glycol and propylene glycol; hydrogenated bisphenol A; and (C2-C3) alkylene oxides adducts of hydrogenated bisphenol A (the average number by mole of the alkylene oxides added: from 1 through 10).

These may be used alone or in combination.

In particular, the polyol preferably includes alkylene glycol in an amount of 40 mol % or more.

Examples of the polycarboxylic acid include dicarboxylic acid.

Examples of the dicarboxylic acid include adipic acid, phthalic acid, isophthalic acid, terephthalic acid, fumaric acid, maleic acid, and C1-C20 alkyl group or C2-C20 alkenyl group-substituted succinic acid (e.g., dodecenyl succinic acid and octyl succinic acid).

These may be used alone or in combination.

In particular, the polycarboxylic acid preferably includes terephthalic acid in an amount of 50 mol % or more.

The non-crystalline polyester resin may include, for example, trivalent or higher carboxylic acid and/or trivalent or higher alcohol, or a trivalent or higher epoxy compound at terminals of the resin chain thereof, to adjust the acid value and the hydroxyl value of the non-crystalline polyester resin.

In particular, the non-crystalline polyester resin preferably includes trivalent or higher aliphatic alcohol and more preferably includes trivalent or tetravalent aliphatic multivalent alcohol having 3 or more and 10 or less carbon atoms. This is because sufficient gloss and image density can be obtained and unevenness is unlikely to occur.

Examples of the trivalent or higher carboxylic acid include trimellitic acid, pyromellitic acid, and anhydrides thereof.

Examples of the trivalent or higher alcohol include glycerin, pentaerythritol, and trimethylolpropane.

Also, the non-crystalline polyester resin component preferably includes a crosslinking component.

The crosslinking component used in the non-crystalline polyester resin component can be, for example, trivalent or higher carboxylic acid or an epoxy compound. More preferably, however, the non-crystalline polyester resin component includes trivalent or higher aliphatic alcohol as the crosslinking component because sufficient gloss and image density can be obtained and unevenness is unlikely to occur.

As the crosslinking component, trivalent or higher aliphatic alcohol is preferably included. From the viewpoints of the gloss and image density of the fixed image, a trivalent or tetravalent aliphatic multivalent alcohol component is more preferably included. The trivalent or tetravalent aliphatic alcohol is preferably a trivalent or tetravalent aliphatic multivalent alcohol component having from 3 through 10 carbon atoms. The crosslinking component may be the trivalent or higher aliphatic alcohol alone.

The trivalent or higher aliphatic alcohol may be appropriately selected in accordance with the intended purpose. Examples of the trivalent or higher aliphatic alcohol include glycerin, trimethylolethane, trimethylolpropane, pentaerythritol, sorbitol, and dipentaerythritol. These trivalent or higher aliphatic alcohols may be used alone or in combination.

The molecular weight of the non-crystalline polyester resin is not particularly limited and may be appropriately selected in accordance with the intended purpose. The molecular weight of the non-crystalline polyester resin is preferably within the following range.

The weight average molecular weight (Mw) of the non-crystalline polyester resin is preferably 3,000 or higher and 10,000 or lower and more preferably 4,000 or higher and 7,000 or lower.

The number average molecular weight (Mn) of the non-crystalline polyester resin is preferably 1,000 or higher and 4,000 or lower and more preferably 1,500 or higher and 3,000 or lower.

A ratio (Mw/Mn) of the molecular weights of the non-crystalline polyester resin is preferably 1.0 or higher and 4.0 or lower and more preferably 1.0 or higher and 3.5 or lower.

The molecular weights can be measured through gel permeation chromatography (GPC).

The above-described ranges of the molecular weights are preferable for the following reasons. Specifically, when the molecular weights are too low, heat-resistant storage stability of the resulting toner and durability thereof against stress, such as stirring inside a developing device, may be impaired. When the molecular weights are too high, viscoelasticity of the resulting toner when it is melted may become higher and therefore low-temperature fixability may be impaired. When the amount of a component having a molecular weight of 600 or lower is too large, heat-resistant storage stability of the resulting toner and durability thereof against stress, such as stirring inside a developing device, may be impaired. When the amount of a component having a molecular weight of 600 or lower is too small, low-temperature fixability of the resulting toner may be impaired.

The amount of a THF-soluble component having a molecular weight of 600 or lower is preferably 2% by mass or more and 10% by mass or less.

Examples of a method of adjusting the amount of the THF-soluble component having a molecular weight of 600 or lower include a method of extracting the non-crystalline polyester resin with methanol to remove the component having a molecular weight of 600 or lower for purification.

The acid value of the non-crystalline polyester resin is not particularly limited and may be appropriately selected in accordance with the intended purpose. The acid value of the non-crystalline polyester resin is preferably 1 mgKOH/g or higher and 50 mgKOH/g or lower and more preferably 5 mgKOH/g or higher and 30 mgKOH/g or lower. When the acid value of the non-crystalline polyester resin is 1 mgKOH/g or higher, the resulting toner tends to be negatively chargeable, and also has good affinity to paper at the time of fixation on the paper, leading to improved low-temperature fixability. When the acid value of the non-crystalline polyester resin is 50 mgKOH/g or lower, a disadvantageous phenomenon associated with charging stability, in particular, reduction in charging stability due to changes in the ambient environment, can be prevented.

The hydroxyl value of the non-crystalline polyester resin is not particularly limited and may be appropriately selected in accordance with the intended purpose. The hydroxyl value of the non-crystalline polyester resin is preferably 5 mgKOH/g or higher.

The glass transition temperature (Tg) of the non-crystalline polyester resin is preferably 40° C. or higher and 65° C. or lower, more preferably 45° C. or higher and 65° C. or lower, and still more preferably 50° C. or higher and 60° C. or lower. When the Tg of the non-crystalline polyester resin is 40° C. or higher, heat-resistant storage stability of the resulting toner and durability thereof against stress, such as stirring inside a developing device, are improved, and anti-filming properties thereof are also improved. When the Tg of the non-crystalline polyester resin is 65° C. or lower, the resulting toner desirably deforms upon application of heat and pressure at the time of fixation, and therefore low-temperature fixability thereof is improved.

The amount of the non-crystalline polyester resin is preferably 80 parts by mass or more and 90 parts by mass or less relative to 100 parts by mass of the toner.

—Crystalline Polyester Resin—

The crystalline polyester resin (hereinafter may be referred to as “crystalline polyester” or “polyester resin component D”) is not particularly limited and may be appropriately selected in accordance with the intended purpose. Examples of the crystalline polyester resin include a crystalline polyester resin obtained through reaction between polyol and polycarboxylic acid.

The crystalline polyester resin has high crystallinity, and therefore exhibits such thermofusion properties that viscosity thereof drastically decreases at a temperature around the fixing onset temperature.

Because the crystalline polyester resin having such properties is used together with the non-crystalline polyester resin, good heat-resistant storage stability is obtained until the melt onset temperature owing to the crystallinity thereof, drastic reduction in viscosity (sharp melt) is caused at the melt onset temperature thereof owing to fusion of the crystalline polyester resin to be compatible to the non-crystalline polyester resin, and the rapid reduction in the viscosity makes the resulting toner to be fixed. Therefore, the toner having both good heat-resistant storage stability and good low-temperature fixability can be obtained. Moreover, a good releasable temperature width (a difference between the minimum fixable temperature and a hot-offset onset temperature) is also obtained.

The crystalline polyester resin is obtained through reaction between multivalent alcohol (polyol) and multivalent carboxylic acid (e.g., multivalent carboxylic acid itself, multivalent carboxylic anhydride, and multivalent carboxylic acid ester) or derivatives thereof.

As described above, the crystalline polyester resin in the present disclosure refers to a product obtained through reaction between polyol and polycarboxylic acid. Any product obtained by modifying the polyester resin, such as the below-described prepolymer, or a resin obtained through crosslinking and/or elongation reaction of the prepolymer is not included in the crystalline polyester resin.

——Multivalent Alcohol (Polyol)——

The multivalent alcohol (polyol) is not particularly limited and may be appropriately selected in accordance with the intended purpose. Examples of the multivalent alcohol (polyol) include diol and trivalent or higher alcohol.

Examples of the diol include saturated aliphatic diol.

Examples of the saturated aliphatic diol include straight-chain saturated aliphatic diol and branched saturated aliphatic diol. These may be used alone or in combination. In particular, straight-chain saturated aliphatic diol is preferable, and straight-chain saturated aliphatic diol having 2 or more and 12 or less carbon atoms is more preferable because use thereof can improve crystallinity and prevent a drop in the melting point thereof.

When the saturated aliphatic diol is branched, crystallinity of the crystalline polyester resin may decrease to cause a drop in the melting point thereof. When the number of carbon atoms in the saturated aliphatic diol exceeds 12, it may be difficult to produce such a material for practical use. The number of carbon atoms therein is more preferably 12 or less.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanediol.

Of these, ethylene glycol, 1,4-butanediol, 1,6-hexanediol, 1,8-octanediol, 1,10-decanediol, and 1,12-dodecanediol are preferable because the resulting crystalline polyester resin has high crystallinity and excellent sharp melting properties.

Examples of the trivalent or higher alcohol include glycerin, trimethylolethane, trimethylolpropane, and pentaerythritol.

——Multivalent Carboxylic Acid (Polycarboxylic Acid) ——

The multivalent carboxylic acid (polycarboxylic acid) is not particularly limited and may be appropriately selected in accordance with the intended purpose. Examples of the multivalent carboxylic acid (polycarboxylic acid) include divalent carboxylic acid and trivalent or higher carboxylic acid.

Examples of the divalent carboxylic acid include: saturated aliphatic dicarboxylic acid, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acid, such as dibasic acid (e.g., phthalic acid, isophthalic acid, terephthalic acid, and naphthalene-2,6-dicarboxylic acid, malonic acid, and mesaconic acid); anhydrides thereof; and lower (C1-C3) alkyl esters thereof.

Examples of the trivalent or higher carboxylic acid include 1,2,4-benzenetricarboxylic acid, 1,2,5-benzenetricarboxylic acid, 1,2,4-naphthalenetricarboxylic acid, anhydrides thereof, and lower (C1-C3) alkyl esters thereof.

In addition to the saturated aliphatic dicarboxylic acid or the aromatic dicarboxylic acid, dicarboxylic acid having a sulfonic acid group may be included as the polycarboxylic acid. In addition to the saturated aliphatic dicarboxylic acid or the aromatic dicarboxylic acid, furthermore, dicarboxylic acid having a double bond may be included. These may be used alone or in combination.

The crystalline polyester resin is preferably formed from straight-chain saturated aliphatic dicarboxylic acid having 4 or more and 12 or less carbon atoms and straight-chain saturated aliphatic diol having 2 or more and 12 or less carbon atoms. In other words, the crystalline polyester resin preferably includes a structural unit derived from the saturated aliphatic dicarboxylic acid having 4 or more and 12 or less carbon atoms and a structural unit derived from the saturated aliphatic diol having 2 or more and 12 or less carbon atoms. The crystalline polyester resin formed therefrom is preferable because it has high crystallinity and excellent sharp melting properties, and thus can exhibit excellent low-temperature fixability.

In the present disclosure, the presence or absence of crystallinity of the crystalline polyester resin can be confirmed with a crystallography X-ray diffractometer (e.g., X'Pert Pro MRD, obtained from Philips). A measurement method therewith is described below.

First, a sample of interest is ground with a pestle and a mortar to prepare a powdered sample. The powdered sample obtained is uniformly applied in a sample holder. After that, the sample holder is set in the diffractometer, followed by measurement, to produce a diffraction spectrum.

When the peak half value width of the peak having the maximum peak intensity among the diffraction peaks obtained in the range of 20°<20<25° is 2.0 or less, it is determined that the sample has crystallinity.

Differing from the crystalline polyester resin, a polyester resin that does not present the above peak pattern is referred to as a non-crystalline polyester resin in the present disclosure.

Measuring conditions of the X-ray diffraction spectroscopy are described below.

[Measuring Conditions]

Tension kV: 45 kV

Current: 40 mA

MPSS

Upper

Gonio

Scanmode: continuous

Start angle: 3°

End angle: 35°

Angle Step: 0.02°

Lucident beam optics

Divergence slit: Div slit 1/2

Deflection beam optics

Anti scatter slit: As Fixed 1/2

Receiving slit: Prog rec slit

The melting point of the crystalline polyester resin is not particularly limited and may be appropriately selected in accordance with the intended purpose. The melting point of the crystalline polyester resin is preferably 60° C. or higher and 80° C. or lower. When the melting point of the crystalline polyester resin is 60° C. or higher, it is possible to prevent degradation of the heat-resistant storage stability of the resulting toner, which would otherwise occur, due to the crystalline polyester resin that readily melts at low temperatures. When the melting point of the crystalline polyester resin is 80° C. or lower, it is possible to prevent degradation of the low-temperature fixability of the resulting toner, which would otherwise occur, due to the crystalline polyester resin that is insufficiently melted by application of heat at the time of fixation.

The molecular weight of the crystalline polyester resin is not particularly limited and may be appropriately selected in accordance with the intended purpose.

The weight average molecular weight (Mw) of the ortho-dichlorobenzene-soluble component of the crystalline polyester resin as measured through GPC is preferably from 3,000 through 30,000 and more preferably from 5,000 through 15,000.

The number average molecular weight (Mn) of the ortho-dichlorobenzene-soluble component of the crystalline polyester resin as measured through GPC is preferably from 1,000 through 10,000 and more preferably from 2,000 through 10,000.

A ratio (Mw)/(Mn) of the molecular weights of the crystalline polyester resin is preferably from 1.0 through 10 and more preferably from 1.0 through 5.0.

The above range of the ratio (Mw)/(Mn) is preferable because the crystalline polyester resin having a sharp molecular weight distribution and a low molecular weight has excellent low-temperature fixability, and heat-resistant storage stability is degraded when the crystalline polyester resin has a large quantity of the component having a low molecular weight.

The acid value of the crystalline polyester resin is not particularly limited and may be appropriately selected in accordance with the intended purpose. In order to achieve desired low-temperature fixability, the acid value of the crystalline polyester resin is preferably 5 mgKOH/g or higher and more preferably 10 mgKOH/g or higher, in terms of affinity between paper and resin. In order to improve hot-offset resistance, conversely, the acid value of the crystalline polyester resin is preferably 45 mgKOH/g or lower.

The hydroxyl value of the crystalline polyester resin is not particularly limited and may be appropriately selected in accordance with the intended purpose. In order to achieve desired low-temperature fixability and good chargeability, the hydroxyl value of the crystalline polyester resin is preferably from 0 mgKOH/g through 50 mgKOH/g and more preferably from 5 mgKOH/g through 50 mgKOH/g.

The molecular structure of the crystalline polyester resin can be confirmed through solution or solid NMR spectroscopy, X-ray diffraction spectroscopy, GC/MS, LC/MS, or IR spectroscopy. One simple method of confirming the molecule structure thereof is a method of detecting, as the crystalline polyester resin, a compound having absorption, which is based on δCH (out-of-plane bending vibration) of olefin, at 965±10 cm⁻¹ or 990±10 cm⁻¹ in an infrared absorption spectrum thereof.

The amount of the crystalline polyester resin is not particularly limited and may be appropriately selected in accordance with the intended purpose. The amount of the crystalline polyester resin is preferably 3 parts by mass or more and 20 parts by mass or less and more preferably 5 parts by mass or more and 15 parts by mass or less relative to 100 parts by mass of the toner. When the amount of the crystalline polyester resin is 3 parts by mass or more, it is possible to prevent degradation of the low-temperature fixability, which would otherwise occur, due to insufficient sharp melting of the crystalline polyester resin. When the amount of the crystalline polyester resin is 20 parts by mass or less, it is possible to prevent degradation of the heat-resistant storage stability and easy occurrence of image fogging, which would otherwise occur.

—Non-Crystalline Hybrid Resin—

The non-crystalline hybrid resin includes one or more resins selected from the group consisting of composite resins each containing a polycondensation resin and a styrene resin. In the non-crystalline hybrid resin, two polymer resin components having different reaction paths are partially chemically bonded, and at least one of the polymer resin components is formed of the same polymer resin component as the polymer resin component of a polyester resin. In the present disclosure, the non-crystalline hybrid resin may be simply referred to as a hybrid resin.

The non-crystalline hybrid resin can improve dispersibility of the crystalline polyester resin in the toner particle.

The non-crystalline hybrid resin controls exposure of the crystalline polyester to the toner surface and uniformly disperses the crystalline polyester inside the toner particle. Thereby, the non-crystalline hybrid resin can contribute to achieving both low-temperature fixability and heat-resistant storage stability.

The non-crystalline hybrid resin is preferably a resin obtained by mixing a mixture of monomers for the two polymer resins having different reaction paths with a monomer reactive with both of the monomers for the two polymer resins (bi-reactive monomer).

The bi-reactive monomer is preferably a monomer having, in a molecule thereof, at least one functional group selected from the group consisting of a hydroxyl group, a carboxyl group, an epoxy group, a primary amino group, and a secondary amino group; and an ethylenically unsaturated bond. The bi-reactive monomer can improve dispersibility of the resin as a disperse phase.

Specific examples of the bi-reactive monomer include acrylic acid, fumaric acid, methacrylic acid, citraconic acid, and maleic acid. Of these, acrylic acid, methacrylic acid, and fumaric acid are preferable.

The amount of the bi-reactive monomer is preferably 0.1 parts by mass or more and 10 parts by mass or less relative to 100 parts by mass of the monomers for the polycondensation resin. In the present disclosure, from the specificity of its properties, the bi-reactive monomer is treated as a monomer different from a monomer for a polycondensation resin and a monomer for an addition polymerization resin.

In the present disclosure, when the non-crystalline hybrid resin is obtained through two different polymerization reactions using the monomer mixture and the bi-reactive monomer as described above, the polymerization reactions may or may not progress and terminate at the same time. In accordance with the respective reaction mechanisms, the reaction temperature and time can be appropriately selected to make the reaction progress and terminate.

An exemplary preferable method of producing the non-crystalline hybrid resin is as follows. Specifically, the monomer for the polycondensation resin, the monomer for the addition polymerization resin, the bi-reactive monomer, and a catalyst such as a polymerization initiator are mixed together, to first produce an addition polymerization resin component having a functional group capable of polycondensation reaction through, mainly, radical polymerization reaction at from 50° C. through 180° C. Next, the reaction temperature is increased to a temperature of from 190° C. through 270° C., to form a polycondensation resin component through, mainly, polycondensation reaction.

The softening point of the non-crystalline hybrid resin is preferably 80° C. or higher and 170° C. or lower, more preferably 90° C. or higher and 160° C. or lower, and still more preferably 95° C. or higher and 155° C. or lower.

A ratio by weight between the crystalline polyester resin and the non-crystalline hybrid resin is not particularly limited and may be appropriately selected in accordance with the intended purpose. For example, the ratio by weight of the polyester resin: the non-crystalline hybrid resin is preferably from 50/100 through 200/100.

As the monomer for the polycondensation resin, a carboxylic acid component used is preferably a succinic acid derivative.

As the monomer for the styrene resin, a styrene derivative, such as styrene itself, α-methylstyrene, or vinyltoluene, is used.

The amount of the styrene derivative is preferably 50% by mass or more, more preferably 70% by mass or more, and still more preferably 80% by mass or more in the monomers for the styrene resin.

Examples of usable monomers for the styrene resin other than the styrene derivative include: (meth)acrylic acid alkyl ester; ethylenically unsaturated monoolefins such as ethylene and propylene; diolefins such as butadiene; halovinyls such as vinyl chloride; vinyl esters such as vinyl acetate and vinyl propionate; esters of ethylenic monocarboxylic acid, such as dimethylaminoethyl (meth)acrylate; vinyl ethers such as vinyl methyl ether; vinylidene halides such as vinylidene chloride; and N-vinyl compounds such as N-vinylpyrrolidone.

Of these, (meth)acrylic acid alkyl ester is preferable from the viewpoint of improving low-temperature fixability and charging stability of the resulting toner.

The number of carbon atoms in the alkyl group of the (meth)acrylic acid alkyl ester is, from the above point of view, preferably from 1 through 22 and more preferably from 8 through 18.

The number of carbon atoms of the alkyl ester refers to the number of carbon atoms derived from an alcohol component forming the ester. Specific examples of the (meth)acrylic acid alkyl ester include methyl (meth)acrylate, ethyl (meth)acrylate, (iso)propyl (meth)acrylate, 2-hydroxyethyl (meth)acrylate, (iso or tertiary)-butyl (meth)acrylate, 2-ethylhexyl (meth)acrylate, (iso)octyl (meth)acrylate, (iso)decyl (meth)acrylate, and (iso)stearyl (meth)acrylate.

The amount of the (meth)acrylic acid alkyl ester is, from the viewpoint of improving low-temperature fixability, heat-resistant storage stability, and charging stability of the resulting toner, preferably 50% by mass or less, more preferably 30% by mass or less, and still more preferably 20% by mass or less in the monomers for the styrene resin.

The amount of the hybrid resin is not particularly limited and may be appropriately selected in accordance with the intended purpose. The amount of the hybrid resin is preferably 15% by mass or more relative to the amount of the crystalline polyester. When the amount of the hybrid resin is less than 15% by mass, an obtainable effect of dispersing the crystalline polyester in the toner particle is low, and an excessive amount of the crystalline polyester may be disposed on the surface of the toner particle.

—Modified Polyester Resin—

The modified polyester resin (hereinafter may be referred to as “modified polyester” or “polyester resin component C”) is not particularly limited and may be appropriately selected in accordance with the intended purpose. Examples of the modified polyester resin include a reaction product between an active hydrogen group-containing compound and a polyester resin having a site reactive with the active hydrogen group-containing compound (which may be referred to as “prepolymer” or “polyester prepolymer” in the present specification). The modified polyester is a polyester resin insoluble in tetrahydrofuran (THF). The polyester resin component insoluble in tetrahydrofuran (THF) reduces the Tg or melt viscosity of the resulting toner to ensure the low-temperature fixability thereof. The polyester resin component insoluble in tetrahydrofuran (THF) has a branched structure in a molecular skeleton thereof, and molecular chains thereof form a three-dimensional network structure. The resulting toner has such rubber-like properties that it deforms at low temperatures but does not flow.

The modified polyester resin has a structure represented by one of the following General Formulae 1) to 3), and in the structure, R2 denoting polyester or a modified polyester moiety is bound via a urethane or urea bond to R1 denoting a branched structure:

R1-(NHCONH—R2)n-; General Formula 1)

R1-(NHCOO—R2)n-; and General Formula 2)

R1-(OCONH—R2)n-, General Formula 3)

where, in the above formulae, n is 3, R1 is an isocyanurate skeleton, and R2 is a group derived from a resin that is polyester containing polycarboxylic acid and polyol or is modified polyester obtained by modifying the polyester with isocyanate.

Because the modified polyester resin includes a urethane bond or a urea bond, or both in the branched structure, the urethane or the urea bond act as a pseudo-crosslink point to enhance rubber-like properties of the modified polyester resin. As a result, a toner excellent in heat-resistant storage stability and hot-offset resistance can be produced.

The modified polyester resin includes a diol component as a constituting component thereof, and further preferably includes a dicarboxylic acid component as a constituting component thereof.

The modified polyester resin is not particularly limited and may be appropriately selected in accordance with the intended purpose, as long as R2, which denotes polyester or a modified polyester moiety, is bound to R1, which denotes a branched structure, via a urethane or urea bond.

How to bind the R1 and the R2 to each other is not particularly limited but includes the following methods, for example:

a) a method of allowing a diol component and a dicarboxylic acid component to undergo esterification reaction to prepare polyester polyol (R2) having a hydroxy group at the terminal thereof, and reacting the prepared polyester polyol with isocyanurate (R1); and

b) a method of allowing a diol component and a dicarboxylic acid component to undergo esterification reaction to prepare polyester polyol (R2) having a hydroxy group at the terminal thereof, reacting the prepared polyester polyol with divalent polyisocyanate to prepare isocyanate-modified polyester (R2), and reacting the isocyanate-modified polyester with isocyanurate (R1) in the presence of pure water.

Alternatively, the hydroxyl group remaining in the polyol obtained by one of the above methods a) and b) may be further reacted with divalent or higher polyisocyanate to prepare a polyester prepolymer, which is then reacted with a curing agent for use in a toner production process.

During the toner production process, the reaction thereof with the curing agent produces a urea or urethane bond that exhibits behaviors like a strong crosslink point, to enhance rubber-like properties of the modified polyester. The resulting toner is further excellent in heat-resistant storage stability and hot-offset resistance. This is why it is more preferable to use a resin of isocyanate-modified polyester as the R2 moiety.

In order to reduce the Tg of the modified polyester resin so that the modified polyester resin readily provides the resulting toner with properties deforming at low temperatures, the modified polyester contains a diol component in constituting components thereof. The diol component preferably contains: a portion to be a main chain thereof, where the portion has 3 or more and 9 or less carbon atoms; and an alkyl group in a side chain thereof. The diol component more preferably contains aliphatic diol having 4 or more and 12 or less carbon atoms.

The modified polyester resin contains the aliphatic diol having 3 or more and 12 or less carbon atoms preferably in an amount of 50 mol % or more, more preferably 80 mol % or more, or still more preferably 90 mol % or more.

Examples of the aliphatic diol having 3 or more and 12 or less carbon atoms include 1,3-propanediol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol.

A particularly preferable modified polyester resin is a modified polyester resin where the diol component is aliphatic diol having 3 or more and 9 or less carbon atoms, the number of carbon atoms to form a main chain of the diol component is an odd number, and the diol component has an alkyl group in a side chain thereof.

The aliphatic diol having 4 or more and 12 or less carbon atoms where the number of carbon atoms to form the main chain is an odd number and the aliphatic diol has an alkyl group in a side chain thereof is, for example, aliphatic diol represented by General Formula (1) below.

HO—(CR1R2)n-OH General Formula (1)

In the General Formula (1), R1 and R2 each independently represent a hydrogen atom or an alkyl group having from 1 through 3 carbon atoms. n is an odd number in the range of from 3 through 9. In the unit repeated n times, R1s may be identical or different and R2s may be identical or different.

In order to reduce the Tg of the modified polyester resin so that the modified polyester resin readily provides the resulting toner with properties deforming at low temperatures, the non-crystalline polyester resin C preferably contains an aliphatic diol having 3 or more and 12 or less carbon atoms in an amount of 50 mol % or more in the whole of the alcohol components.

In order to reduce the Tg of the modified polyester resin so that the modified polyester resin readily provides the resulting toner with properties deforming at low temperatures, preferably, the non-crystalline polyester resin C contains a dicarboxylic acid component in constituting components thereof and the dicarboxylic acid component contains aliphatic dicarboxylic acid having 4 or more and 12 or less carbon atoms.

The polyester resin preferably contains the aliphatic dicarboxylic acid having 4 or more and 12 or less carbon atoms in an amount of 30 mol % or more.

Examples of the aliphatic dicarboxylic acid having 4 or more and 12 or less carbon atoms include succinic acid, glutaric acid, adipic acid, pimelic acid, suberic acid, azelaic acid, sebacic acid, and dodecanedioic acid.

—Diol Component—

The diol component is not particularly limited and may be appropriately selected in accordance with the intended purpose. Examples of the diol component include aliphatic diol such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol; diol having an oxyalkylene group, such as diethylene glycol, triethylene glycol, dipropylene glycol, polyethylene glycol, polypropylene glycol, and polytetramethylene glycol; alicyclic diol such as 1,4-cyclohexanedimethanol and hydrogenated bisphenol A; adducts obtained by adding alkylene oxides (e.g., ethylene oxide, propylene oxide, and butylene oxide) to alicyclic diol; bisphenol such as bisphenol A, bisphenol F, and bisphenol S; and alkylene oxide adducts of bisphenol, such as adducts obtained by adding alkylene oxides (e.g., ethylene oxide, propylene oxide, and butylene oxide) to bisphenol. In particular, the aliphatic diol having 4 or more and 12 or less carbon atoms is preferable.

These may be used alone or in combination.

—Dicarboxylic Acid Component—

The dicarboxylic acid component is not particularly limited and may be appropriately selected in accordance with the intended purpose. Examples of the dicarboxylic acid component include aliphatic dicarboxylic acid and aromatic dicarboxylic acid. Also, anhydrides thereof, lower (C1-C3) alkyl esters thereof, and halides thereof may be used.

The aliphatic dicarboxylic acid is not particularly limited and may be appropriately selected in accordance with the intended purpose. Examples of the aliphatic dicarboxylic acid include succinic acid, adipic acid, sebacic acid, dodecanedioic acid, maleic acid, and fumaric acid.

The aromatic dicarboxylic acid is not particularly limited and may be appropriately selected in accordance with the intended purpose. The aromatic dicarboxylic acid is preferably aromatic dicarboxylic acid having 8 or more and 20 or less carbon atoms.

The aromatic dicarboxylic acid having 8 or more and 20 or less carbon atoms is not particularly limited and may be appropriately selected in accordance with the intended purpose.

Examples of the aromatic dicarboxylic acid having 8 or more and 20 or less carbon atoms include phthalic acid, isophthalic acid, terephthalic acid, and naphthalene dicarboxylic acid.

In particular, the aliphatic dicarboxylic acid having 4 or more and 12 or less carbon atoms is preferable.

These may be used alone or in combination.

—Trivalent or Higher Alcohol—

The trivalent or higher alcohol is not particularly limited and may be appropriately selected in accordance with the intended purpose. Examples of the trivalent or higher alcohol include trivalent or higher aliphatic alcohol, trivalent or higher polyphenol, and an alkylene oxide adduct of trivalent or higher polyphenol.

Examples of the trivalent or higher aliphatic alcohol include glycerin, trimethylolethane, trimethylolpropane, pentaerythritol, and sorbitol. Examples of the trivalent or higher polyphenol include trisphenol PA, phenol novolac, and cresol novolac.

Examples of the alkylene oxide adduct of trivalent or higher polyphenol include alkylene oxide (e.g., ethylene oxide, propylene oxide, and butylene oxide) adducts of trivalent or higher polyols.

—Polyisocyanate—

The polyisocyante is not particularly limited and may be appropriately selected in accordance with the intended purpose. Examples of the polyisocyante include diisocyanate and trivalent or higher isocyanate.

Examples of the diisocyanate include aliphatic diisocyanate, alicyclic diisocyanate, aromatic diisocyanate, aromatic aliphatic diisocyanate, isocyanurate, and products obtained by blocking these with a phenol derivative, oxime, or caprolactam.

Examples of the trivalent or higher isocyanate include lysine triisocyanate, products obtained by reacting trivalent or higher alcohol with diisocyanate, and products obtained by reacting polyisocyanate so as to have an isocyanurate skeleton.

Of these, polyisocyanate having an isocyanurate skeleton is preferably used because it produces stronger crosslinking points and the resulting toner is excellent in heat-resistant storage stability and hot-offset resistance.

The trivalent isocyanate component is preferably 0.2 mol % or more and 1.0 mol % or less relative to the resin component in the THF-insoluble components of the toner.

When a crosslinked structure is formed by the trivalent isocyanate component, an aggregation force of molecular chains through pseudo crosslinking by urethane or urea bonds at the crosslinking points increases. Thereby, the resulting toner can have heat-resistant storage stability enhanced even at a lower crosslinking density and low-temperature fixability achieved at a high level.

The trivalent isocyanate component less than 0.2 mol % leads to insufficient formation of a branched structure. When sites where the network structure becomes ununiform are start points, the resulting toner may be degraded in heat-resistant storage stability and low-temperature fixability.

The trivalent isocyanate component more than 1.0 mol % may form a densely crosslinked structure to degrade the low-temperature fixability of the resulting toner.

The aliphatic diisocyanate is not particularly limited and may be appropriately selected in accordance with the intended purpose. Examples of the aliphatic diisocyanate include tetramethylene diisocyanate, hexamethylene diisocyanate, methyl 2,6-diisocyanatocaproate, octamethylene diisocyanate, decamethylene diisocyanate, dodecamethylene diisocyanate, tetradecamethylene diisocyanate, trimethylhexane diisocyanate, and tetramethylhexane diisocyanate.

The alicyclic diisocyanate is not particularly limited and may be appropriately selected in accordance with the intended purpose. Examples of the alicyclic diisocyanate include isophorone diisocyanate and cyclohexylmethane diisocyanate.

The aromatic diisocyanate is not particularly limited and may be appropriately selected in accordance with the intended purpose. Examples of the aromatic diisocyanate include tolylene diisocyanate, diisocyanatodiphenyl methane, 1,5-naphthylenediisocyanate, 4,4′-diisocyanatodiphenyl, 4,4′-diisocyanato-3,3′-dimethyldiphenyl, 4,4′-diisocyanato-3-methyldiphenylmethane, and 4,4′-diisocyanato-diphenyl ether. The aromatic aliphatic diisocyanate is not particularly limited and may be appropriately selected in accordance with the intended purpose. Examples of the aromatic aliphatic diisocyanate include α,α,α′,α′-tetramethylxylylene diisocyanate.

The isocyanurate is not particularly limited and may be appropriately selected in accordance with the intended purpose. Examples of the isocyanurate include tris(isocyanatoalkyl) isocyanurate and tris (isocyanatocycloalkyl) isocyanurate.

These may be used alone or in combination.

<Resin Particles>

The resin particles are present on the surface of each of the toner base particles.

Each of the resin particles preferably includes a core resin (a core) and a shell resin (a shell) covering at least part of the surface of the core resin. More preferably, the resin particle is formed of a core resin (hereinafter may be referred to as “resin (b2)”) and a shell resin (hereinafter may be referred to as “resin (b1)”). Still more preferably, the shell resin (b1) and the core resin (b2) include vinyl units.

The vinyl units in the shell resin (b1) and the core resin (b2) are preferably polymers obtained by homopolymerizing or copolymerizing vinyl monomers.

Examples of the vinyl monomers include the following (1) to (10).

(1) Vinyl Hydrocarbon

Examples of the vinyl hydrocarbon include (1-1) aliphatic vinyl hydrocarbon, (1-2) alicyclic vinyl hydrocarbon, and (1-3) aromatic vinyl hydrocarbon.

(1-1) Aliphatic Vinyl Hydrocarbon

Examples of the aliphatic vinyl hydrocarbon include alkene and alkadiene.

Specific examples of the alkene include ethylene, propylene, and α-olefin.

Specific examples of the alkadiene include butadiene, isoprene, 1,4-pentadiene, 1,6-hexadiene, and 1,7-octadiene.

(1-2) Alicyclic Vinyl Hydrocarbon

Examples of the alicyclic vinyl hydrocarbon include monocycloalkene, dicycloalkene, and alkadiene. Specific examples of the alicyclic vinyl hydrocarbon include (di)cyclopentadiene and terpene.

(1-3) Aromatic Vinyl Hydrocarbon

Examples of the aromatic vinyl hydrocarbon include styrene, and hydrocarbyl (alkyl, cycloalkyl, aralkyl, and/or alkenyl)-substituted styrene. Specific examples of the aromatic vinyl hydrocarbon include α-methylstyrene, 2,4-dimethylstyrene, and vinyl naphthalene.

(2) Carboxyl Group-Containing Vinyl Monomer and Salts Thereof

Examples of the carboxyl group-containing vinyl monomer and salts thereof include C3-C30 unsaturated monocarboxylic acid (salt), unsaturated dicarboxylic acid (salt), anhydrides (salts) thereof, and monoalkyl (C1-C24) esters thereof or salts thereof.

Specific examples of the carboxyl group-containing vinyl monomer and salts thereof include: carboxyl group-containing vinyl monomers, such as (meth)acrylic acid, maleic (anhydride), maleic acid monoalkyl ester, fumaric acid, fumaric acid monoalkyl ester, crotonic acid, itaconic acid, itaconic acid monoalkyl ester, itaconic acid glycol monoether, citraconic acid monoalkyl ester, and cinnamic acid; and metal salts thereof.

In the present disclosure, the term “acid (salt)” means acid or a salt of the acid.

For example, the C3-C30 unsaturated monocarboxylic acid (salt) means an unsaturated monocarboxylic acid or a salt of the unsaturated monocarboxylic acid.

In the present disclosure, the term “(meth)acryl” means methacrylic acid or acrylic acid.

In the present disclosure, the term “(meth)acryloyl” means methacryloyl or acryloyl.

In the present disclosure, the term “(meth)acrylate” means methacrylate or acrylate.

(3) Sulfonic Acid Group-Containing Vinyl Monomer, Vinyl Sulfuric Acid Monoester Compound, and Salts Thereof

Examples of the sulfonic acid group-containing vinyl monomer, vinyl sulfuric acid monoester compound, and salts thereof include C2-C14 alkene sulfonic acid (salt), C2-C24 alkyl sulfonic acid (salt), sulfo(hydroxy)alkyl-(meth)acrylate (salt), sulfo(hydroxy)alkyl-(meth)acrylamide (salt), and alkylallylsulfosuccinic acid (salt).

Specific examples of the C2-C14 alkene sulfonic acid include vinyl sulfonic acid (salt). Specific examples of the C2-C24 alkyl sulfonic acid (salt) include α-methylstyrenesulfonic acid (salt). Specific examples of the sulfo(hydroxy)alkyl-(meth)acrylate (salt) or the sulfo(hydroxy)alkyl-(meth)acrylamide (salt) include sulfopropyl(meth)acrylate (salt), sulfuric acid ester (salt), and a sulfonic acid group-containing vinyl monomer (salt).

(4) Phosphoric Acid Group-Containing Vinyl Monomer and Salts Thereof

Examples of the phosphoric acid group-containing vinyl monomer and salts thereof include (meth)acryloyloxyalkyl (C1-C24) phosphoric acid monoester (salt) and (meth)acryloyloxyalkyl (C1-C24) phosphonic acid (salt).

Specific examples of the (meth)acryloyloxyalkyl (C1-C24) phosphoric acid monoester (salt) include 2-hydroxyethyl(meth)acryloyl phosphate (salt) and phenyl-2-acryloyloxyethyl phosphate (salt).

Specific examples of the (meth)acryloyloxyalkyl (C1-C24) phosphonic acid (salt) include 2-acryloyloxyethylphosphonic acid (salt).

Examples of salts of the above (2) to (4) include alkali metal salts (e.g., sodium salt and potassium salt), alkaline earth metal salts (e.g., calcium salt and magnesium salt), ammonium salts, amine salts, and quaternary ammonium salts.

(5) Hydroxyl Group-Containing Vinyl Monomer

Examples of the hydroxyl group-containing vinyl monomer include hydroxystyrene, N-methylol (meth)acrylamide, hydroxyethyl (meth)acrylate, hydroxypropyl (meth)acrylate, polyethylene glycol mono(meth)acrylate, (meth)allyl alcohol, crotyl alcohol, isocrotyl alcohol, 1-buten-3-ol, 2-buten-1-ol, 2-butane-1,4-diol, propargylalcohol, 2-hydroxyethylpropenyl ether, and sucrose allyl ether.

(6) Nitrogen-Containing Vinyl Monomer

Examples of the nitrogen-containing vinyl monomer include (6-1) an amino group-containing vinyl monomer, (6-2) an amide group-containing vinyl monomer, (6-3) a nitrile group-containing vinyl monomer, (6-4) a quaternary ammonium cation group-containing vinyl monomer, and (6-5) a nitro group-containing vinyl monomer.

Examples of the (6-1) amino group-containing vinyl monomer include aminoethyl (meth)acrylate.

Examples of the (6-2) amide group-containing vinyl monomer include (meth)acrylamide and N-methyl (meth)acrylamide.

Examples of the (6-3) nitrile group-containing vinyl monomer include (meth)acrylonitrile, cyanostyrene, and cyanoacrylate.

Examples of the (6-4) quaternary ammonium cation group-containing vinyl monomer include a quaternized compound (quaternized using a quaternizing agent, such as methyl chloride, dimethyl sulfate, benzyl chloride, and dimethyl carbonate) of a tertiary amine group-containing vinyl monomer (e.g., dimethylaminoethyl (meth)acrylate, diethylaminoethyl (meth)acrylate, dimethylaminoethyl (meth)acrylamide, diethylaminoethyl (meth)acrylamide, and diallylamine).

Examples of the (6-5) nitro group-containing vinyl monomer include nitrostyrene.

(7) Epoxy Group-Containing Vinyl Monomer

Examples of the epoxy group-containing vinyl monomer include glycidyl (meth)acrylate, tetrahydrofurfuryl (meth)acrylate, and p-vinylphenylphenyloxide.

(8) Halogen Element-Containing Vinyl Monomer

Examples of the halogen element-containing vinyl monomer include vinyl chloride, vinyl bromide, vinylidene chloride, allyl chloride, chlorostyrene, bromostyrene, dichlorostyrene, chloromethylstyrene, tetrafluorostyrene, and chloroprene.

(9) Vinyl Ester, Vinyl (Thio)Ether, Vinyl Ketone

Examples of the vinyl ester include vinyl acetate, vinyl butyrate, vinyl propionate, vinyl butyrate, diallyl phthalate, diallyl adipate, isopropenyl acetate, vinyl methacrylate, methyl 4-vinylbenzoate, cyclohexyl methacrylate, benzyl methacrylate, phenyl (meth)acrylate, vinyl methoxy acetate, vinyl benzoate, ethyl α-ethoxyacrylate, C1-C50 alkyl group-containing alkyl(meth)acrylate [e.g., methyl (meth)acrylate, ethyl (meth)acrylate, propyl (meth)acrylate, butyl (meth)acrylate, 2-ethylhexyl (meth)acrylate, dodecyl (meth)acrylate, hexadecyl (meth)acrylate, heptadecyl (meth)acrylate, octadecyl (meth)acrylate, eicosyl (meth)acrylate, and behenyl (meth)acrylate)], dialkyl fumarate (where two alkyl groups are each a C2-C8 straight-chain or branched-chain alicyclic group), dialkyl maleate (where two alkyl groups are each a C2-C8 straight-chain, branched-chain, or alicyclic group), poly(meth)allyloxy alkane [e.g., diallyloxy ethane, triallyloxy ethane, tetraallyloxy ethane, tetraallyloxy propane, tetraallyloxy butane, and tetrametha-allyloxy ethane], a polyalkylene glycol chain-containing vinyl monomer [e.g., polyethylene glycol (molecular weight: 300) mono(meth)acrylate, polypropylene glycol (molecular weight: 500) monoacrylate, (meth)acrylate of a methyl alcohol ethylene oxide (10 mol) adduct, and (meth)acrylate of a lauryl alcohol ethylene oxide (30 mol) adduct], and poly(meth)acrylate [e.g., poly(meth)acrylate of multivalent alcohol:ethylene glycol di(meth)acrylate, propylene glycol di(meth)acrylate, neopentyl glycol di(meth)acrylate, trimethylolpropane tri(meth)acrylate, and polyethylene glycol di(meth)acrylate].

Examples of the vinyl (thio)ether include vinyl methyl ether.

Examples of the vinyl ketone include methyl vinyl ketone.

(10) Other Vinyl Monomers

Examples of the other vinyl monomers include tetrafluoroethylene, fluoroacrylate, isocyanatoethyl (meth)acrylate, and m-isopropenyl-α,α-dimethylbenzyl isocyanate.

For synthesis of the shell resin (b1), the above vinyl monomers (1) to (10) may be used alone or in combination.

From the viewpoint of improving low-temperature fixability of the resulting toner, the shell resin (b1) is preferably a styrene-(meth)acrylic acid ester copolymer or a (meth)acrylic acid ester copolymer, with a styrene-(meth)acrylic acid ester copolymer being more preferable.

When the shell resin (b1) includes carboxylic acid, an acid value is given to the resin, and a toner particle including resin particles on the surface thereof is readily formed.

Examples of the vinyl monomer used for the core resin (b2) include similar vinyl monomers used for the shell resin (b1).

For synthesis of the core resin (b2), the above vinyl monomers (1) to (10) exemplified for the shell resin (b1) may be used alone or in combination.

From the viewpoint of improving low-temperature fixability of the resulting toner, the core resin (b2) is preferably a styrene-(meth)acrylic acid ester copolymer or a (meth)acrylic acid ester copolymer, with a styrene-(meth)acrylic acid ester copolymer being more preferable.

The viscoelastic loss modulus G″ of the shell resin (b1) at 100° C. and a frequency of 1 Hz is preferably 1.5 MPa or higher and 100 MPa or lower, more preferably 1.7 MPa or higher and 30 MPa or lower, and still more preferably 2.0 MPa or higher and 10 MPa or lower.

The viscoelastic loss modulus G″ of the core resin (b2) at 100° C. and a frequency of 1 Hz is preferably 0.01 MPa or higher and 1.0 MPa or lower, more preferably 0.02 MPa or higher and 0.5 MPa or lower, and still more preferably 0.05 MPa or higher and 0.3 MPa or lower.

When the viscoelastic loss modulus G″ is within one of the above ranges, it is easier to form a toner particle including, on the surface thereof, resin particles each including the shell resin (b1) and the core resin (b2) as constituting components thereof.

The viscoelastic loss modulus G″ of the shell resin (b1) and the core resin (b2) at 100° C. and a frequency of 1 Hz can be adjusted by varying monomers for use and a blending ratio thereof, and adjusting polymerization conditions (e.g., an initiator for use and an amount thereof, a chain-transfer agent for use and an amount thereof, and a reaction temperature).

Specifically, for example, the G″ of each of the resins can be adjusted to the above range by adjusting the composition of each resin as follows.

(1) Tg1 is adjusted to preferably 0° C. or higher and 150° C. or lower and more preferably 50° C. or higher and 100° C. or lower, where Tg1 is a glass transition temperature calculated from the monomers for the shell resin (b1). Tg2 is adjusted to preferably −30° C. or higher and 100° C. or lower, more preferably 0° C. or higher and 80° C. or lower, and still more preferably 30° C. or higher and 60° C. or lower, where Tg2 is a glass transition temperature calculated from the monomers for the core resin (b2).

The glass transition temperature (Tg) calculated from the constituting monomers is a value calculated according to the Fox method.

The Fox method [T. G. Fox, Phys. Rev., 86, 652 (1952)] is a method of estimating Tg of a copolymer from Tg of each homopolymer as presented by the following formula.

1/Tg=W1/Tg1+W2/Tg2+ . . . +Wn/Tgn

[In the formula above, Tg is a glass transition temperature (as an absolute temperature) of a copolymer, Tg1, Tg2 . . . Tgn are each a glass transition temperature (as an absolute temperature) of a homopolymer of each monomer component, and W1, W2 . . . Wn are each a weight fraction of each monomer component.]

(2) (AV1) is adjusted to preferably 75 mgKOH/g or higher and 400 mgKOH/g or lower and more preferably 150 mgKOH/g or higher and 300 mgKOH/g or lower, where (AV1) is a calculated acid value of the shell resin (b1). Moreover, (AV2) is adjusted to preferably 0 mgKOH/g or higher and 50 mgKOH/g or lower, more preferably 0 mgKOH/g or higher and 20 mgKOH/g or lower, and still more preferably 0 mgKOH/g, where (AV2) is a calculated acid value of the core resin (b2).

Note that, the calculated acid value is a theoretical acid value calculated from the amount by mole of acidic groups contained in the constituting monomers and the total weight of the constituting monomers.

In order to satisfy the conditions of the above (1) and (2), the shell resin (b1) is, for example, a resin including: styrene, as constituting monomers thereof, preferably in an amount of 10% by mass or more and 80% by mass or less and more preferably 30% by mass or more and 60% by mass or less relative to the total mass of the shell resin (b1); and methacrylic acid and/or acrylic acid preferably in the combined amount of 10% by mass or more and 60% by mass or less and more preferably 30% by mass or more and 50% by mass or less relative to the total mass of the shell resin (b1).

Meanwhile, the core resin (b2) is, for example, a resin including: styrene, as constituting monomers thereof, preferably in an amount of 10% by mass or more and 100% by mass or less and more preferably 30% by mass or more and 90% by mass or less relative to the total mass of the core resin (b2); and methacrylic acid and/or acrylic acid preferably in the combined amount of 0% by mass or more and 7.5% by mass or less and more preferably 0% by mass or more and 2.5% by mass or less relative to the total mass of the core resin (b2).

(3) Polymerization conditions (e.g., an initiator for use and an amount thereof, a chain-transfer agent for use and an amount thereof, and a reaction temperature) are adjusted. Specifically, the number average molecular weight (Mn1) of the shell resin (b1) is adjusted to preferably 2,000 or higher and 2,000,000 or lower and more preferably 20,000 or higher and 200,000 or lower, and the number average molecular weight (Mn2) of the core resin (b2) is adjusted to preferably 1,000 or higher and 1,000,000 or lower and more preferably 10,000 or higher and 100,000 or lower.

The viscoelastic loss modulus G″ in the present disclosure is measured with, for example, the following rheometer.

Device: ARES-24A (obtained from Rheometric Scientific)

Jig: 25 mm parallel plate

Frequency: 1 Hz

Distortion factor: 10%

Heating rate: 5° C./min

The acid value (AVb1) of the shell resin (b1) is preferably 75 mgKOH/g or higher and 400 mgKOH/g or lower and more preferably 150 mgKOH/g or higher and 300 mgKOH/g or lower.

When the acid value (AVb1) of the shell resin (b1) is within one of the above ranges, it is easier to form a toner particle including, on the surface thereof, resin particles each including the vinyl units and including the shell resin (b1) and the core resin (b2) as constituting components thereof.

The shell resin (b1) having the acid value in the above range is a resin including methacrylic acid and/or acrylic acid preferably in the combined amount of 10% by mass or more and 60% by mass or less and more preferably 30% by mass or more and 50% by mass or less relative to the total mass of the shell resin (b1).

The acid value (AVb2) of the core resin (b2) is preferably 0 mgKOH/g or higher and 50 mgKOH/g or lower, more preferably 0 mgKOH/g or higher and 20 mgKOH/g or lower, and still more preferably 0 mgKOH/g, from the viewpoint of improving the low-temperature fixability of the resulting toner.

The core resin (b2) having the acid value (Avb2) in the above range is a resin including methacrylic acid and/or acrylic acid preferably in the combined amount of 0% by mass or more and 7.5% by mass or less and more preferably 0% by mass or more and 2.5% by mass or less relative to the total mass of the core resin (b2).

The acid value in the present disclosure is measured by the method according to JIS K0070:1992.

The glass transition temperature of the shell resin (b1) is preferably higher than the glass transition temperature of the core resin (b2), more preferably higher by 10° C. or higher, and more preferably higher by 20° C. or higher.

When the glass transition temperature of the shell resin (b1) is within one of the above ranges, it is possible to strike a good balance between easiness to form a toner particle including resin particles on the surface of the toner particle and the low-temperature fixability of the toner particle of the present disclosure.

The glass transition temperature (hereinafter may be abbreviated as “Tg”) of the shell resin (b1) is preferably 0° C. or higher and 150° C. or lower and more preferably 50° C. or higher and 100° C. or lower.

When the glass transition temperature of the shell resin (b1) is 0° C. or higher, the heat-resistant storage stability of the resulting toner can be improved. When the glass transition temperature of the shell resin (b1) is 150° C. or lower, the low-temperature fixability of the resulting toner is not degraded very much.

The Tg of the core resin (b2) is preferably −30° C. or higher and 100° C. or lower, more preferably 0° C. or higher and 80° C. or lower, and still more preferably 30° C. or higher and 60° C. or lower. When the glass transition temperature of the core resin (b2) is −30° C. or higher, the heat-resistant storage stability of the resulting toner can be improved. When the glass transition temperature of the core resin (b2) is 100° C. or lower, the low-temperature fixability of the resulting toner is not degraded very much.

The Tg in the present disclosure is measured with “DSC20, SSC/580” (obtained from Seiko Instruments Inc.) by the method (DSC) stipulated in ASTM D3418-82.

The solubility parameter (hereinafter may be abbreviated as “SP value”) of the shell resin (b1) is, from the viewpoint of readily forming toner particles, preferably 9 (cal/cm³)^{1/2} or higher and 13 (cal/cm³)^{1/2} or lower, more preferably 9.5 (cal/cm³)^{1/2} or higher and 12.5 (cal/cm³)^{1/2} or lower, and still more preferably 10.5 (cal/cm³)^{1/2} or higher and 11.5 (cal/cm³)^{1/2} or lower.

The SP value of the shell resin (b1) can be adjusted by changing monomers used to constitute the shell resin (b1) and a compositional ratio thereof.

The SP value of the core resin (b2) is, from the viewpoint of readily forming toner particles, preferably 8.5 (cal/cm³)^{1/2} or higher and 12.5 (cal/cm³)^{1/2} or lower, more preferably 9 (cal/cm³)^{1/2} or higher and 12 (cal/cm³)^{1/2} or lower, and still more preferably 10 (cal/cm³)^{1/2} or higher and 11 (cal/cm³)^{1/2} or lower.

The SP value of the core resin (b2) can be adjusted by changing monomers used to constitute core resin (b2) and a compositional ratio thereof.

The SP value in the present disclosure is calculated by the method of Fedors [Polym. Eng. Sci. 14 (2)152, (1974)].

From the viewpoints of the Tg of the shell resin (b1) and copolymerizability with other monomers, the shell resin (b1) contains styrene, as a constituting monomer thereof, preferably in an amount of 10% by mass or more and 80% by mass or less and more preferably 30% by mass or more and 60% by mass or less relative to the total mass of the shell resin (b1).

From the viewpoints of the Tg of the core resin (b2) and copolymerizability with other monomers, the core resin (b2) contains styrene, as a constituting monomer thereof, preferably in an amount of 10% by mass or more and 100% by mass or less and more preferably 30% by mass or more and 90% by mass or less relative to the total mass of the core resin (b2).

The number average molecular weight (Mn) of the shell resin (b1) is preferably 2,000 or higher and 2,000,000 or lower and more preferably 20,000 or higher and 200,000 or lower. When the number average molecular weight (Mn) of the shell resin (b1) is 2,000 or higher, the heat-resistant storage stability of the resulting toner is improved. When the number average molecular weight (Mn) of the shell resin (b1) is 2,000,000 or lower, the low-temperature fixability of the resulting toner is not degraded very much.

The weight average molecular weight of the shell resin (b1) is preferably higher than the weight average molecular weight of the core resin (b2), more preferably 1.5 times or greater as high as the weight average molecular weight of the core resin (b2), and still more preferably 2.0 times or greater as high as the weight average molecular weight of the core resin (b2). When the weight average molecular weight of the shell resin (b1) is within one of the above ranges, it is possible to strike a good balance between easiness to form a toner particle and the low-temperature fixability of the toner particle.

The weight average molecular weight (Mw) of the shell resin (b1) is preferably 20,000 or higher and 20,000,000 or lower and more preferably 200,000 or higher and 2,000,000 or lower. When the weight average molecular weight (Mw) of the shell resin (b1) is 20,000 or higher, the heat-resistant storage stability of the resulting toner is improved. When the weight average molecular weight (Mw) of the shell resin (b1) is 20,000,000 or lower, the low-temperature fixability of the resulting toner is not degraded very much.

The Mn of the core resin (b2) is preferably 1,000 or higher and 1,000,000 or lower and more preferably 10,000 or higher and 100,000 or lower. When the Mn of the core resin (b2) is 1,000 or higher, the heat-resistant storage stability of the resulting toner is improved. When the Mn of the core resin (b2) is 1,000,000 or lower, the low-temperature fixability of the resulting toner is not degraded very much.

The Mw of the core resin (b2) is preferably 10,000 or higher and 10,000,000 or lower and more preferably 100,000 or higher and 1,000,000 or lower. When the Mw of the core resin (b2) is 10,000 or higher, the heat-resistant storage stability of the resulting toner is improved. When the Mw of the core resin (b2) is 10,000,000 or lower, the low-temperature fixability of the resulting toner is not degraded very much.

Particularly preferably, the Mw of the shell resin (b1) is 200,000 or higher and 2,000,000 or lower, the Mw of the core resin (b2) is 100,000 or higher and 500,000 or lower, and the relationship of [Mw of (b1)]>[Mw of (b2)] is true.

The Mn and Mw in the present disclosure can be measured through gel permeation chromatography (GPC) under the following conditions.

Device (as one example): “HLC-8120”, [obtained from Tosoh Corporation]

Columns (as one example): 2 columns of “TSK GEL GMH6”, [obtained from Tosoh Corporation]

Measuring temperature: 40° C.

Sample solution: 0.25% by mass tetrahydrofuran solution (from which an insoluble component is separated through filtration with a glass filter)

Amount of solution injected: 100 μL

Detection device: refractive index detector

Reference materials: 12 samples of standard polystyrene (TSKstandard POLYSTYRENE) (molecular weights: 500, 1,050, 2,800, 5,970, 9,100, 18,100, 37,900, 96,400, 190,000, 355,000, 1,090,000, and 2,890,000) [obtained from Tosoh Corporation]

A weight ratio (the shell resin (b1)/the core resin (b2)) of the shell resin (b1) to the core resin (b2) in the resin particles is preferably 5/95 or higher and 95/5 or lower, more preferably 25/75 or higher and 75/25 or lower, and still more preferably 40/60 or higher and 60/40 or lower. When the weight ratio of the shell resin (b1) to the core resin (b2) is 5/95 or higher, the resulting toner has excellent heat-resistant storage stability. When the weight ratio of the shell resin (b1) to the core resin (b2) is 95/5 or lower, it is easier to form a toner particle including the resin particles on the surface of a toner resin particle.

Although the resin particles may be used alone, the toner of the present disclosure is also obtained by using resin particles formed of two styrene-acrylic resins (resins b1 and b2) and resin particles formed of one styrene-acrylic resin in combination.

The resin particles mixed in advance are uniformly deposited on the toner surface during emulsification. All or part of the resin particles and the resin b1 on the toner surface is removed in the below-described washing step. Thereby, it is possible to uniformly deposit the resin particles with gaps therebetween.

As a method of producing the resin particles, any publicly known production method may be exemplified. Examples of the publicly known production method include the following production methods (I) to (V):

(I) a method in which constituting monomers of the core resin (b2) are polymerized through seed polymerization using, as seeds, particles of the shell resin (b1) in an aqueous dispersion liquid;

(II) a method in which constituting monomers of the shell resin (b1) are polymerized through seed polymerization using, as seeds, particles of the core resin (b2) in an aqueous dispersion liquid;

(III) a method in which a mixture of the shell resin (b1) and the core resin (b2) is emulsified in an aqueous medium to produce an aqueous dispersion liquid of resin particles;

(IV) a method in which a mixture of the shell resin (b1) and constituting monomers of the core resin (b2) is emulsified in an aqueous medium, followed by polymerization of the constituting monomers of the core resin (b2), to produce an aqueous dispersion liquid of resin particles; and

(V) a method in which a mixture of the core resin (b2) and constituting monomers of the shell resin (b1) is emulsified in an aqueous medium, followed by polymerization of the constituting monomers of the shell resin (b1), to produce an aqueous dispersion liquid of resin particles.

Whether the resin particles each include the shell resin (b1) and the core resin (b2) as constituting components thereof can be confirmed by observing an element mapping image of a cross-sectional surface of each of the resin particles under a publicly known surface elemental analyzer (e.g., TOF-SIMSEDX-SEM) or by observing an electron microscope image of a cross-sectional surface of each of the resin particles that are dyed with a dyeing agent selected in accordance with the functional groups contained the shell resin (b1) and the core resin (b2).

The resin particles obtained by the above method may be a mixture of resin particles each including only the shell resin (b1) as a constituting resin component thereof and resin particles each including only the core resin (b2) as a constituting resin component, as well as the resin particles each including the shell resin (b1) and the core resin (b2) as constituting components thereof. In the below-described composite-forming step, the resin particles may be used as the mixture obtained, or only the resin particles may be separated for use.

Specific examples of the method (I) include: a method in which the constituting monomers of the (b1) are dripped and polymerized to produce an aqueous dispersion liquid of resin particles including the (b1), followed by seed polymerization of the constituting monomers of the (b2) using, as seeds, the resin particles including the (b1); and a method in which the (b1), which has been produced in advance through, for example, solution polymerization, is emulsified and dispersed in water, followed by seed polymerization of the constituting monomers of the (b2) using the (b1) as seeds.

Specific examples of the method (II) include: a method in which the constituting monomers of the (b2) are dripped and polymerized to produce an aqueous dispersion liquid of resin particles, followed by seed polymerization of the constituting monomers of the (b1) using the resin particles as seeds; and a method in which the (b2), which has been produced in advance through, for example, solution polymerization, is emulsified and dispersed in water, followed by seed polymerization of the constituting monomers of the (b1) using the (b2) as seeds.

Specific examples of the method (III) include a method in which solutions or melts of the (b1) and the (b2), which have been produced in advance through solution polymerization, are mixed together, followed by emulsifying and dispersing of the resulting mixture into an aqueous medium.

Specific examples of the method (IV) include: a method in which the (b1), which has been produced in advance through, for example, solution polymerization, is mixed with the constituting monomers of the (b2), and the resulting mixture is emulsified and dispersed in an aqueous medium, followed by polymerization of the constituting monomers of the (b2); and a method in which the (b1) is produced in the constituting monomers of the (b2), and the resulting mixture is emulsified and dispersed in an aqueous medium, followed by polymerization of the constitutional monomers of the (b2).

Specific examples of the method (V) include: a method in which the (b2), which has been produced in advance through, for example, solution polymerization, is mixed with the constituting monomers of the (b1), and the resulting mixture is emulsified and dispersed in an aqueous medium, followed by polymerization of the constituting monomers of the (b1); and a method in which the (b2) is produced in the constitutional monomers of the (b1), and the resulting mixture is emulsified and dispersed in an aqueous medium, followed by polymerization of the constituting monomers of the (b1).

In the present disclosure, any of the production methods (I) to (V) as described above is suitable.

The resin particles are preferably used in the state of an aqueous dispersion liquid of the resin particles.

The volume average particle diameter of the resin particles in the dispersion liquid of the resin particles is preferably 10 nm or more and 40 nm or less. When the volume average primary particle diameter is 10 nm or more, the resulting toner has improved heat-resistant storage stability. When the volume average primary particle diameter is 40 nm or less, the resulting toner has improved low-temperature fixability.

<Measurement of Particle Diameter of Resin Particles on the Toner Surface>

The particle diameter of the resin particles on the toner surface can be confirmed in the following manner.

—Method of Liberating External Additive—

[1] A 100 mL screw vial was charged with 50 mL of a 5% by mass aqueous surfactant solution (product name: NOIGEN ET-165, obtained from DKS Co., Ltd.). The solution in the vial was mixed with 3 g of the toner. The vial was gently moved in up-to-down and left-to-right motions. After that, the resulting mixture was stirred in a ball mill for 30 min to uniformly disperse the toner in the dispersion liquid.

[2] Then, ultrasonic energy was applied to the resulting mixture for 60 minutes with an ultrasonic homogenizer (product name: homogenizer, model: VCX750, CV33, obtained from SONICS & MATERIALS, Inc.) with the output being set to 40 W.

—Conditions of Ultrasonic Waves—

Vibration duration: continuous 60 minutes

Amplitude: 40 W

Vibration onset temperature: 23±1.5° C.

Temperature during vibration: 23±1.5° C.

[3] (1) The dispersion liquid was subjected to vacuum filtration with filter paper (product name: Qualitative filter paper (No. 2, 110 mm), obtained from Advantec Toyo Kaisha, Ltd.). The resulting product was washed twice with ion-exchanged water, followed by filtration. After removal of the additive that had been liberated, the toner particles were dried.

(2) The toner obtained in the above (1) was observed under a scanning electron microscope (SEM). First, a backscattered electron image was observed to detect the external additive and filler containing Si.

(3) The image obtained in the above (2) was binarized using image processing software (ImageJ), to eliminate the external additive and filler.

Next, the toner at the same position as in the above (2) was observed to produce a secondary electron image. The resin particles are not observed in the backscattered electron image, but are observed only in the secondary electron image. In comparison to the image obtained in the above (3), therefore, the particles present in the region other than the residual external additive and filler (i.e., the other region than the region excluded in the above (3)) were determined as the resin particles. The above image processing software was used to measure a particle diameter of the resin particles.

Materials used for the aqueous dispersion liquid (aqueous medium) are not particularly limited and may be appropriately selected in accordance with the intended purpose, as long as the materials can be dissolved in water. Examples of the materials include a surfactant (D), a buffer, and a protective colloid. These may be used alone or in combination.

The aqueous medium used for the aqueous dispersion liquid is not particularly limited as long as the aqueous medium is a liquid containing water. Examples of the aqueous medium include an aqueous solution containing water.

The resin particles are preferably used in the state of an aqueous dispersion liquid. The aqueous medium of the dispersion liquid may be any liquid containing water. Examples of the aqueous medium include an aqueous solution containing a surfactant (D) in water.

Examples of the surfactant (D) include a nonionic surfactant (D1), an anionic surfactant (D2), a cationic surfactant (D3), an amphoteric surfactant (D4), and other emulsification dispersants (D5).

Examples of the nonionic surfactant (D1) include an alkylene oxide (AO) adduct-type nonionic surfactant and a multivalent alcohol-type nonionic surfactant.

Examples of the AO adduct-type nonionic surfactant include a C10-C20 aliphatic alcohol EO adduct, a phenol EO adduct, a nonyl phenol ethylene oxide (EO) adduct, a C8-C22 alkyl amine EO adduct, and a poly(oxypropylene)glycol EO adduct.

Examples of the multivalent alcohol-type nonionic surfactant include multivalent (from trivalent through octavalent or higher) alcohol (C2-C30) fatty acid (C8-C24) ester (e.g., glycerin monostearate, glycerin monooleate, sorbitan monolaurate, and sorbitan monooleate), and alkyl (C4-C24) poly (degree of polymerization: from 1 through 10) glucoside.

Examples of the anionic surfactant (D2) include C8-C24 hydrocarbon group-containing ether carboxylic acid or salts thereof, C8-C24 hydrocarbon group-containing sulfuric acid ester or ether sulfuric acid ester and salts thereof, C8-C24 hydrocarbon group-containing sulfonic acid salts, sulfosuccinic acid salts including one or two C8-C24 hydrocarbon groups, C8-C24 hydrocarbon group-containing phosphoric acid ester or ether phosphoric acid ester and salts thereof, C8-C24 hydrocarbon group-containing fatty acid salts, and C8-C24 hydrocarbon group-containing acylated amino acid salts.

Examples of the C8-C24 hydrocarbon group-containing ether carboxylic acid or salts thereof include sodium lauryl ether acetate and sodium (poly)oxyethylene (the number of moles added: from 1 through 100) lauryl ether acetate.

Examples of the C8-C24 hydrocarbon group-containing sulfuric acid ester or ether sulfuric acid ester and salts thereof include sodium lauryl sulfate, sodium (poly)oxyethylene (the number of moles added: from 1 through 100) lauryl sulfate, triethanolamine (poly)oxyethylene (the number of moles added: from 1 through 100) lauryl sulfate, and (poly)oxyethylene (the number of moles added: from 1 through 100) coconut fatty acid monoethanolamide sodium sulfate.

Examples of the C8-C24 hydrocarbon group-containing sulfonic acid salts include sodium dodecylbenzene sulfonate.

Examples of the C8-C24 hydrocarbon group-containing phosphoric acid ester or ether phosphoric acid ester and salts thereof include sodium lauryl phosphate and sodium (poly)oxyethylene (the number of moles added: from 1 through 100) lauryl ether phosphate.

Examples of the C8-C24 hydrocarbon group-containing fatty acid salts include sodium laurate and triethanolamine laurate.

Examples of the C8-C24 hydrocarbon group-containing acylated amino acid salts include sodium methyl cocoyl taurate, sodium cocoyl sarcosinate, triethanolamine cocoyl sarcosinate, triethanolamine N-cocoyl-L-glutamate, sodium N-cocoyl-L-glutamate, and lauroylmethyl-β-alanine sodium salt.

Examples of the cationic surfactant (D3) include a quaternary ammonium salt-type cationic surfactant and an amine salt-type cationic surfactant.

Examples of the quaternary ammonium salt-type cationic surfactant include trimethyl stearyl ammonium chloride, behenyl trimethyl ammonium chloride, distearyl dimethyl ammonium chloride, and N—(N′-lanolin fatty acid amide propyl)N-ethyl-N,N-dimethyl ammonium ethyl sulfate.

Examples of the amine salt-type cationic surfactant include stearic acid diethylaminoethylamide lactic acid salt, dilaurylamine hydrochloride, and oleylamine lactate.

Examples of the amphoteric surfactant (D4) include a betaine-type amphoteric surfactant and an amino acid-type amphoteric surfactant.

Examples of the betaine-type amphoteric surfactant include coconut oil fatty acid amidepropyldimethylaminoacetic acid betaine, lauryl dimethylaminoacetic acid betaine, 2-alkyl-N-carboxymethyl-N-hydroxyethylimidazolinium betaine, and lauryl hydroxysulfobetaine.

Examples of the amino acid-type amphoteric surfactant include sodium β-laurylaminopropionate.

Examples of other emulsification dispersants (D5) include a reaction active agent.

The reaction active agent is not particularly limited and may be appropriately selected in accordance with the intended purpose, as long as the reaction active agent has radical reactivity. Examples of the reaction active agent include: ADEKA REASOAP (registered trademark) SE-10N, SR-10, SR-20, SR-30, ER-20, and ER-30 (all of which are obtained from ADEKA CORPORATION); AQUALON (registered trademark), HS-10, KH-05, KH-10, and KH-1025 (all of which are obtained from DKS Co., Ltd.); ELEMINOL (registered trademark) JS-20 (obtained from SANYO CHEMICAL, LTD.); LATEMUL (registered trademark) D-104, PD-420, and PD-430 (obtained from Kao Corporation); IONET (registered trademark) MO-200 (obtained from SANYO CHEMICAL, LTD.); polyvinyl alcohol; starch and derivatives thereof; cellulose derivatives, such as carboxymethyl cellulose, methyl cellulose, and hydroxyethyl cellulose; carboxyl group-containing (co)polymer, such as polyacrylic acid soda; and urethane group or ester group-containing emulsification dispersants (e.g., a compound obtained by linking polycaprolactone polyol and polyether diol via polyisocyanate) disclosed in U.S. Pat. No. 5,906,704.

From the viewpoint of stabilizing oil droplets to have desired shapes and making the particle size distribution sharp during emulsification and dispersion, the surfactant (D) is preferably (D1), (D2), (D5), or a combination thereof, and a combination of (D1) and (D5) or a combination of (D2) and (D5) is more preferable.

Examples of the buffer include sodium acetate, sodium citrate, and sodium bicarbonate.

Examples of the protective colloid include a water-soluble cellulose compound and an alkali metal salt of polymethacrylic acid.

The resin particles may each include, in addition to the shell resin (b1) and the core resin (b2), other resin components, an initiator (and a residue thereof), a chain-transfer agent, an antioxidant, a plasticizer, a preservative, a reducing agent, an organic solvent, etc.

Examples of the other resin components include a vinyl resin excluding the resins used for the shell resin (b1) and the core resin (b2), a polyurethane resin, an epoxy resin, a polyester resin, a polyamide resin, a polyimide resin, a silicone resin, a phenol resin, a melamine resin, a urea resin, an aniline resin, an ionomer resin, and a polycarbonate resin.

Examples of the initiator (and the residue thereof) include publicly known radical polymerization initiators. Specific examples of the publicly known radical polymerization initiators include: a persulfuric acid salt initiator, such as potassium persulfate and ammonium persulfate; an azo initiator, such as azobisisobutyronitrile; organic peroxide, such as benzoyl peroxide, cumene hydroperoxide, tert-butyl hydroperoxide, tert-butyl peroxyisopropyl monocarbonate, and tert-butyl peroxybenzoate; and hydrogen peroxide.

Examples of the chain-transfer agent include n-dodecylmercaptan, tert-dodecylmercaptan, n-butylmercaptan, 2-ethylhexyl thioglycolate, 2-mercaptoethanol, β-mercaptopropionic acid, and α-methylstyrene dimer.

Examples of the antioxidant include a phenol compound, para-phenylenediamine, hydroquinone, an organic sulfur compound, and an organophosphorus compound.

Examples of the phenol compound include 2,6-di-t-butyl-p-cresol, butylated hydroxyanisole, 2,6-di-t-butyl-4-ethylphenol, stearyl-p-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris-(3,5-di-t-butyl-4-hydroxybenzyl)benzene, tetrakis-[methylene-3-(3′, 5′-di-t-butyl-4′-hydroxyphenyl)propionate]methane, bis[3,3′-bis(4′-hydroxy-3′-t-butylphenyl)butyric acid]glycol ester, and tocopherol.

Examples of the para-phenylenediamine include N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

Examples of the hydroquinone include 2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

Examples of the organic sulfur compound include dilauryl-3,3′-thiodipropionate, distearyl-3,3′-thiodipropionate, and ditetradecyl-3,3′-thiodipropionate.

Examples of the organophosphorus compound include triphenylphosphine, tri(nonylphenyl)phosphine, tri(dinonylphenyl)phosphine, tricresyl phosphate, and tri(2,4-dibutylphenoxy)phosphine.

Examples of the plasticizer include phthalic acid ester, aliphatic diprotic acid ester, trimellitic acid ester, phosphoric acid ester, and fatty acid ester.

Examples of the phthalic acid ester include dibutyl phthalate, dioctyl phthalate, butylbenzyl phthalate, and isodecyl phthalate.

Examples of the aliphatic diprotic acid ester include di-2-ethylhexyl adipate and 2-ethylhexyl sebacate.

Examples of the trimellitic acid ester include tri-2-ethylhexyl trimellitate and trioctyl trimellitate.

Examples of the phosphoric acid ester include triethyl phosphate, tri-2-ethylhexyl phosphate, and tricresyl phosphate.

Examples of the fatty acid ester include butyl oleate.

Examples of the preservative include an organic nitrogen sulfur compound preservative and an organic sulfur halogenated compound preservative.

Examples of the reducing agent include: a reducing organic compound, such as ascorbic acid, tartaric acid, citric acid, glucose, and formaldehyde sulfoxylate metal salt; and a reducing inorganic compound, such as sodium thiosulfate, sodium sulfite, sodium bisulfite, and sodium metabisulfite.

Examples of the organic solvent include: a ketone solvent, such as acetone and methyl ethyl ketone (hereinafter may be abbreviated as MEK); an ester solvent, such as ethyl acetate and γ-butyrolactone; an ether solvent, such as tetrahydrofuran (THF); an amide solvent, such as N,N-dimethylformamide, N,N-dimethylacetamide, N-methyl-2-pyrrolidone, and N-methylcaprolactam; an alcohol solvent, such as isopropyl alcohol; and an aromatic hydrocarbon solvent, such as toluene and xylene.

The amount of the resin particles is preferably 0.2% by mass or more and 5% by mass or less relative to the toner. When the sum of the amount of the shell resin (b1) and the amount of the core resin (b2) is within one of the above ranges, the resulting toner is improved in low-temperature fixability and heat-resistant storage stability. When the amount of the resin particles is 0.2% by mass or more relative to the toner, it is possible to prevent degradation of the heat-resistant storage stability of the resulting toner, which would otherwise occur. When the amount of the resin particles is 5% by mass or less, it is possible to prevent degradation of the low-temperature fixability of the resulting toner, which would otherwise occur.

<Other Components>

The other components are not particularly limited and may be appropriately selected in accordance with the intended purpose. Examples of the other components include a release agent, a colorant, a charge controlling agent, an external additive, a flowability improving agent, a cleanability improving agent, and a magnetic material.

—Release Agent—

The release agent is not particularly limited and may be appropriately selected in accordance with the intended purpose. Examples of the release agent include: natural wax, such as vegetable wax (e.g., carnauba wax, cotton wax, and Japanese wax), animal wax (e.g., bees wax and lanolin wax), mineral wax (e.g., ozocerite and ceresin), and petroleum wax (e.g., paraffin wax, microcrystalline wax, and petrolatum wax); synthetic hydrocarbon wax (e.g., Fischer-Tropsch wax, polyethylene wax, and polypropylene wax); and synthetic wax (e.g., ester, ketone, and ether). Of these, paraffin wax, microcrystalline wax, and hydrocarbon wax (e.g., Fischer-Tropsch wax, polyethylene wax, and polypropylene wax) are preferable.

Further examples of the release agent include: fatty acid amide compounds (e.g., 12-hydroxystearic acid amide, stearic acid amide, phthalimide anhydride, and chlorinated hydrocarbon); homopolymers or copolymers of polyacrylate (e.g., poly-n-stearyl methacrylate and poly-n-lauryl methacrylate that are low-molecular-weight crystalline polymeric resins (examples of the copolymers including a n-stearyl acrylate-ethyl methacrylate copolymer)); and a crystalline polymer having a long alkyl chain in a side chain thereof.

The melting point of the release agent is not particularly limited and may be appropriately selected in accordance with the intended purpose. The melting point of the release agent is preferably 60° C. or higher and 80° C. or lower.

When the melting point of the release agent is lower than 60° C., the release agent readily melts at low temperatures and consequently may result in degradation of the heat-resistant storage stability of the resulting toner.

When the melting point of the release agent is higher than 80° C., there may be a deficiency in an image due to fixation offset caused through insufficient melting of the release agent even when the resin is melted and the temperature is in the fixable temperature range.

The amount of the release agent is not particularly limited and may be appropriately selected in accordance with the intended purpose. The amount of the release agent is preferably from 2 parts by mass through 10 parts by mass and more preferably from 3 parts by mass through 8 parts by mass relative to 100 parts by mass of the toner.

—Colorant—

The colorant is not particularly limited and may be appropriately selected in accordance with the intended purpose. Examples of the colorant include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL, F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS, BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone.

The amount of the colorant is not particularly limited and may be appropriately selected in accordance with the intended purpose. The amount of the colorant is preferably 1 part by mass or more and 15 parts by mass or less and more preferably 3 parts by mass or more and 10 parts by mass or less relative to 100 parts by mass of the toner.

The colorant may be used also as a masterbatch in which the colorant forms a composite with a resin.

Examples of the resin used for production of the masterbatch or kneaded together with the masterbatch include, in addition to the above polyester resins: polymers of styrene or substituted styrene, such as polystyrene, poly(p-chlorostyrene), and polyvinyl toluene; styrene copolymers, such as a styrene-p-chlorostyrene copolymer, a styrene-propylene copolymer, a styrene-vinyltoluene copolymer, a styrene-vinylnaphthalene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-methyl α-chloromethacrylate copolymer, a styrene-acrylonitrile copolymer, a styrene-methyl vinyl ketone copolymer, a styrene-butadiene copolymer, a styrene-isoprene copolymer, a styrene-acrylonitrile-indene copolymer, a styrene-maleic acid copolymer, and a styrene-maleic acid ester copolymer; polymethyl methacrylate, polybutyl methacrylate, polyvinyl chloride, polyvinyl acetate, polyethylene, polypropylene, polyester, an epoxy resin, an epoxypolyol resin, polyurethane, polyamide, polyvinyl butyral, a polyacrylic resin, rosin, modified rosin, a terpene resin, an aliphatic or alicyclic hydrocarbon resin, an aromatic petroleum resin, chlorinated paraffin, and paraffin wax. These may be used alone or in combination.

—External Additive—

As the external additive, it is possible to use oxide particles, inorganic particles, and hydrophobicity-imparted inorganic particles in combination. The average particle diameter of the primary particles of the external additive is preferably from 1 nm through 100 nm and more preferably from 5 nm through 70 nm.

The external additive preferably includes at least one group of hydrophobicity-imparted inorganic particles having an average particle diameter of primary particles of 20 nm or less and at least one group of hydrophobicity-imparted inorganic particles having an average particle diameter of primary particles of 30 nm or more.

The specific surface area of the external additive by the BET method is preferably from 20 m²/g through 500 m²/g.

The external additive is not particularly limited and may be appropriately selected in accordance with the intended purpose. Examples of the external additive include silica particles, hydrophobic silica, fatty acid metal salts (e.g., zinc stearate and aluminum stearate), metal oxides (e.g., titania, alumina, tin oxide, and antimony oxide), and a fluoropolymer.

Examples of suitable additives include hydrophobicity-imparted silica, titania, titanium oxide, and alumina particles. Examples of the silica particles include R972, R974, RX200, RY200, R202, R805, and R812 (all of which are obtained from NIPPON AEROSIL CO., LTD.). Examples of the titania particles include: P-25 (obtained from NIPPON AEROSIL CO., LTD.); STT-30 and STT-65C-S(both of which are obtained from Titan Kogyo, Ltd.); TAF-140 (obtained from Fuji Titanium Industry Co., Ltd.); and MT-150W, MT-500B, MT-600B, and MT-150A (all of which are obtained from TAYCA CORPORATION).

Examples of the hydrophobicity-imparted titanium oxide particles include: T-805 (obtained from NIPPON AEROSIL CO., LTD.); STT-30A and STT-65S-S (both of which are obtained from Titan Kogyo, Ltd.); TAF-500T and TAF-1500T (both of which are obtained from Fuji Titanium Industry Co., Ltd.); MT-100S and MT-100T (both of which are obtained from TAYCA CORPORATION); and IT-S(obtained from ISHIHARA SANGYO KAISHA, LTD.).

Examples of the silicone oil include dimethylsilicone oil, methylphenylsilicone oil, chlorophenylsilicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacrylic-modified silicone oil, and α-methylstyrene-modified silicone oil.

Examples of the inorganic particles include silica, alumina, titanium oxide, barium titanate, magnesium titanate, calcium titanate, strontium titanate, iron oxide, copper oxide, zinc oxide, tin oxide, silica sand, clay, mica, wollastonite, diatomite, chromium oxide, cerium oxide, red iron oxide, antimony trioxide, magnesium oxide, zirconium oxide, barium sulfate, barium carbonate, calcium carbonate, silicon carbide, and silicon nitride. Of these, silica and titanium dioxide are particularly preferable.

The amount of the external additive is not particularly limited and may be appropriately selected in accordance with the intended purpose. The amount of the external additive is preferably from 0.1 parts by mass through 5 parts by mass and more preferably from 0.3 parts by mass through 3 parts by mass relative to 100 parts by mass of the toner.

The average particle diameter of the primary particles of the inorganic particles is preferably 100 nm or less and more preferably 3 nm or more and 70 nm or less.

—Flowability Improving Agent—

The flowability improving agent is not particularly limited and may be appropriately selected in accordance with the intended purpose, as long as the flowability improving agent is an agent used for a surface treatment to be able to increase hydrophobicity to prevent degradation of flowability and charging properties even in high-humidity environment. Examples of the flowability improving agent include a silane coupling agent, a silylating agent, a fluoroalkyl group-containing silane coupling agent, an organic titanate coupling agent, an aluminum coupling agent, silicone oil, and modified silicone oil.

Particularly preferably, the silica and the titanium oxide are subjected to a surface treatment with any of the above flowability improving agents, and are used as hydrophobic silica and hydrophobic titanium oxide.

—Cleanability Improving Agent—

The cleanability improving agent is not particularly limited and may be appropriately selected in accordance with the intended purpose, as long as the cleanability improving agent is an agent added to the toner in order for the developer remaining after transfer to be removed from a photoconductor or a primary transfer medium. Examples of the cleanability improving agent include: fatty acid (e.g., stearic acid) metal salts, such as zinc stearate and calcium stearate; and polymer particles produced through soap-free emulsion polymerization, such as polymethyl methacrylate particles and polystyrene particles.

The polymer particles preferably have a relatively narrow particle size distribution and suitably have a volume average particle diameter of from 0.01 μm through 1 μm.

—Magnetic Material—

The magnetic material is not particularly limited and may be appropriately selected in accordance with the intended purpose. Examples of the magnetic material include iron powder, magnetite, and ferrite. Of these, white magnetic materials are preferable from the viewpoint of color tone.

<Toner Producing Method>

A toner producing method is not particularly limited and may be appropriately selected in accordance with the intended purpose. The toner producing method is preferably forming particles by dispersing, in an aqueous medium, an oil phase that contains the polyester resin component and if necessary further contains the crystalline polyester resin, the release agent, the colorant, etc.

Also, the toner producing method is more preferably forming particles by dispersing, in an aqueous medium, the oil phase that contains, if necessary, the modified polyester, the curing agent, the release agent, the colorant, etc.

Examples such a toner producing method include a publicly known dissolution suspension method.

As one example thereof, a method of forming toner base particles while producing a polyester resin through either or both of elongation reaction and crosslinking reaction between the prepolymer and the curing agent will be described.

This method includes preparation of an aqueous medium, preparation of an oil phase containing toner materials, emulsification and dispersion of the toner materials, and removal of an organic solvent.

—Preparation of Aqueous Medium (Aqueous Phase)—

The preparation of the aqueous medium can be performed by dispersing the resin particles in an aqueous medium. The amount of the resin particles added to the aqueous medium is not particularly limited and may be appropriately selected in accordance with the intended purpose. The amount of the resin particles is preferably 0.5 parts by mass or more and 10 parts by mass or less relative to 100 parts by mass of the aqueous medium.

The aqueous medium is not particularly limited and may be appropriately selected in accordance with the intended purpose. Examples of the aqueous medium include water, a solvent miscible with water, and a mixture thereof. These may be used alone or in combination. Of these, water is preferable.

The solvent miscible with water is not particularly limited and may be appropriately selected in accordance with the intended purpose. Examples of the solvent miscible with water include alcohol, dimethyl formamide, tetrahydrofuran, cellosolves, and lower ketones. Examples of the alcohol include methanol, isopropanol, and ethylene glycol. Examples of the lower ketones include acetone and methyl ethyl ketone.

—Preparation of Oil Phase—

The preparation of the oil phase containing the toner materials in the present embodiment can be performed by dissolving and dispersing toner materials in an organic solvent, where the toner materials contain: polyester resins A and B, that is, prepolymers each having a urethane bond or a urea bond, or both; and polyester resin C that does not have a urethane bond or a urea bond, or both; and if necessary, further contain the crystalline polyester resin, the curing agent, the release agent, the colorant, etc.

The organic solvent is not particularly limited and may be appropriately selected in accordance with the intended purpose. The organic solvent preferably has a boiling point of lower than 150° C. because such an organic solvent can be readily removed.

Examples of the organic solvent having a boiling point of lower than 150° C. include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone.

These may be used alone or in combination.

Of these, ethyl acetate, toluene, xylene, benzene, methylene chloride, 1,2-dichloroethane, chloroform, and carbon tetrachloride are preferable, with ethyl acetate being more preferable.

—Emulsifying and Dispersing—

The emulsifying and dispersing the toner materials can be performed by dispersing the oil phase including the toner materials in the aqueous medium. When the toner materials are emulsified and dispersed, the curing agent and the prepolymer can be allowed to undergo either or both of elongation reaction and crosslinking reaction.

The reaction conditions for producing the prepolymer (e.g., a reaction time and a reaction temperature) are not particularly limited and may be appropriately selected in accordance with a combination of the curing agent and the prepolymer. The reaction time is preferably 10 minutes or longer and 40 hours or shorter and more preferably 2 hours or longer and 24 hours or shorter. The reaction temperature is preferably 0° C. or higher and 150° C. or lower and more preferably 40° C. or higher and 98° C. or lower.

A method of stably forming a dispersion liquid containing the prepolymer in the aqueous medium is not particularly limited and may be appropriately selected in accordance with the intended purpose. Examples of the method include a method in which the oil phase prepared by dissolving and dispersing the toner materials is added to the aqueous medium phase and the resulting mixture is dispersed by application of a shearing force.

A disperser used for the dispersing is not particularly limited and may be appropriately selected in accordance with the intended purpose. Examples of the disperser include a low-speed shearing disperser, a high-speed shearing disperser, a friction disperser, a high-pressure jet disperser, and an ultrasonic disperser. Of these, a high-speed shearing disperser is preferable because the particle diameter of the dispersoids (oil droplets) can be adjusted to be 2 μm or greater and 20 μm or smaller.

In the case where the high-speed shearing disperser is used, conditions in use thereof, such as a rotational speed, a dispersion time, and a dispersion temperature, are appropriately selected in accordance with the intended purpose. The rotational speed is preferably 1,000 rpm or higher and 30,000 rpm or lower and more preferably 5,000 rpm or higher and 20,000 rpm or lower. In the case of a batch system, the dispersion time is preferably 0.1 minutes or longer and 5 minutes or shorter. The dispersion temperature under pressure is preferably 0° C. or higher and 150° C. or lower and more preferably 40° C. or higher and 98° C. or lower. In general, the higher the temperature, the easier liquid disperses.

The amount of the aqueous medium used for emulsifying and dispersing the toner materials is not particularly limited and may be appropriately selected in accordance with the intended purpose. The amount of the aqueous medium used is preferably 50 parts by mass or more and 2,000 parts by mass or less and more preferably 100 parts by mass or more and 1,000 parts by mass or less relative to 100 parts by mass of the toner materials. When the amount of the aqueous medium used is less than 50 parts by mass, the dispersion state of the toner materials becomes degraded, and the toner base particles having the predetermined particle diameters cannot be obtained in some cases. When the amount of the aqueous medium used is more than 2,000 parts by mass, the production cost may become higher.

When the oil phase containing the toner materials is emulsified and dispersed, a dispersant is preferably used from the viewpoint of stabilizing dispersoids, such as oil droplets, to achieve desired shapes and make the particle size distribution sharp.

The dispersant is not particularly limited and may be appropriately selected in accordance with the intended purpose. Examples of the dispersant include a surfactant, a poorly water-soluble inorganic compound dispersant, and a polymeric protective colloid. These may be used alone or in combination. Of these, a surfactant is preferable.

The surfactant is not particularly limited and may be appropriately selected in accordance with the intended purpose. For example, an anionic surfactant, a cationic surfactant, a nonionic surfactant, or an amphoteric surfactant may be used. Examples of the anionic surfactant include alkyl benzene sulfonic acid salt, α-olefin sulfonic acid salt, and phosphoric acid ester. Of these, a surfactant containing a fluoroalkyl group is preferable.

—Removal of Organic Solvent—

A method of removing the organic solvent from the dispersion liquid, such as the emulsified slurry, is not particularly limited and may be appropriately selected in accordance with the intended purpose. Examples of the method include: a method in which the entire reaction system is gradually heated to evaporate the organic solvent in the oil droplets; and a method in which the dispersion liquid is sprayed to a dry atmosphere to remove the organic solvent in the oil droplets.

Once the organic solvent has been removed, toner base particles are formed. The toner base particles can be subjected to treatments such as washing and drying, and further subjected to classification. The classification may be performed by removing microparticles with, for example, a hydrocyclone, a decanter, or a centrifuge. Alternatively, the classification may be performed after drying.

Examples of a method of removing part or all of the resin (b1) in the washing step include a method in which part or all of the resin (b1) is removed by a chemical method.

Examples of preferable removing processes by a chemical method include a method in which an alkaline aqueous solution is added to the toner base particles, followed by mixing, to dissolve part or all of the resin (b1).

Examples of the alkali in the alkaline aqueous solution include: alkali metal hydroxides, such as potassium hydroxide and sodium hydroxide; and ammonia.

From the viewpoint of readily dissolving the resin (a1), potassium hydroxide and sodium hydroxide are preferable.

The pH of the alkali in the alkaline aqueous solution is preferably from 8 through 14 and further preferably from 10 through 12.

Mixing of the toner base particles and the alkaline aqueous solution in the washing step can be performed by, for example, a method in which the alkaline aqueous solution is dripped into a slurry of the toner base particles under stirring.

Moreover, an acid aqueous solution may be dripped for neutralization.

The obtained toner base particles may be mixed with particles of, for example, the external additive and the charge controlling agent. By application of a mechanical impact, the particles of, for example, the external additive can be prevented from being detached from the surfaces of the toner base particles.

A method of applying the mechanical impact is not particularly limited and may be appropriately selected in accordance with the intended purpose. Examples of the method include: a method in which an impact force is applied to the mixture using a blade rotating at a high speed; and a method in which the mixture is added to a high-speed air flow to accelerate the particles to make the particles crush to each other or make the particles crush into an appropriate impact board.

A device used for the above method is not particularly limited and may be appropriately selected in accordance with the intended purpose. Examples of the device include an ANGMILL (obtained from HOSOKAWA MICRON CORPORATION), a device obtained by modifying an I-type mill (obtained from Nippon Pneumatic Mfg. Co., Ltd.) so as to reduce the pulverization air pressure thereof, a hybridization system (obtained from NARA MACHINERY CO., LTD.), Kryptron System (obtained from Kawasaki Heavy Industries, Ltd.), and an automatic mortar.

(Developer)

A developer of the present disclosure includes the toner of the present disclosure. If necessary, the developer may further include appropriately selected other components, such as a carrier. Therefore, the developer of the present disclosure is excellent in, for example, transferability and chargeability, and can stably form a high-quality image. The developer may be a one-component developer or two-component developer. In the case where the developer is used for high-speed printers in response to the information processing speed increased in recent years, the developer is preferably a two-component developer because the service life thereof is extended.

In the case of using the developer as a one-component developer, even when the toner is used and supplied repeatedly, the toner has a less degree of change in the toner particle diameter. This leads to less degrees of filming of the toner on a developing roller and fusion of the toner to members such as a blade configured to form a thin toner layer. Even after long-term stirring in a developing device, excellent developability can be ensured by the developer. Thus, a high-quality image can be obtained.

In the case of using the developer as a two-component developer, even when the toner is used and supplied repeatedly for a long period of time, the toner has a less degree of change in the toner particle diameter. Even after long-term stirring in a developing device, the developer can produce good, stable developability and images.

<Carrier>

The carrier is not particularly limited and may be appropriately selected in accordance with the intended purpose. The carrier preferably includes a core and a resin layer covering the core.

—Core—

A material of the core is not particularly limited and may be appropriately selected in accordance with the intended purpose. Examples of the material include a manganese-strontium material of 50 emu/g or higher and 90 emu/g or lower and a manganese-magnesium material of 50 emu/g or higher and 90 emu/g or lower. In order to ensure sufficient image density, moreover, a hard magnetic material, such as iron powder of 100 emu/g or higher and magnetite of 75 emu/g or higher and 120 emu/g or lower, is preferably used. A soft magnetic material, such as a copper-zinc material of 30 emu/g or higher and 80 emu/g or lower, is preferably used because an impact of the developer held in the form of a brush against the photoconductor can be reduced, and a high image quality can be achieved.

These may be used alone or in combination.

The volume average particle diameter of the core is not particularly limited and may be appropriately selected in accordance with the intended purpose. The volume average particle diameter of the core is preferably 10 μm or more and 150 μm or less and more preferably 40 μm or more and 100 μm or less. When the volume average particle diameter of the core is less than 10 μm, a larger amount of fine powder is contained in the carrier, leading to a drop in the magnetization per particle and consequently causing scattering of the carrier. When the volume average particle diameter of the core is more than 150 μm, the specific surface area of the core may be reduced thereby causing scattering of the toner. Also, in a full-color image with a large area of a solid portion, especially, reproducibility of the solid portion may be degraded.

The toner of the present disclosure may be mixed with the carrier, to be used as a two-component developer.

The amount of the carrier in the two-component developer is not particularly limited and may be appropriately selected in accordance with the intended purpose. The amount of the carrier is preferably 90 parts by mass or more and 98 parts by mass or less and more preferably 93 parts by mass or more and 97 parts by mass or less relative to 100 parts by mass of the two-component developer.

The developer of the present disclosure can be suitably used for image formation according to various publicly known electrophotographic methods, such as a magnetic one-component developing method, a non-magnetic one-component developing method, and a two-component developing method.

(Toner Storing Unit)

The toner storing unit of the present disclosure is not particularly limited and may be appropriately selected from publicly known ones. Examples of the toner storing unit include a toner storing unit including a container body and a cap.

Also, the size, shape, structure, material, etc. of the container body are not particularly limited, but the shape of the container body is preferably, for example, a hollow cylindrical shape. A particularly preferable container body has spiral concave and convex portions on the inner circumferential surface. When such a container body is rotated, a developer contained therein can be moved to the side of an ejection port. Part or all of the spiral concave and convex portions preferably has a function of a bellows. The material of the container body preferably has good dimensional precision. Examples of the material include resin materials such as a polyester resin, a polyethylene resin, a polypropylene resin, a polystyrene resin, a polyvinyl chloride resin, a polyacrylic resin, a polycarbonate resin component ABS resin, and a polyacetal resin.

The toner storing unit is readily stored and transported, and is excellent in handleability. The toner storing unit is attached in a detachable manner to, for example, a process cartridge or an image forming apparatus that is described below. Thus, the toner storing unit can be used for replenishment of the developer.

The toner storing unit is molded so as to be detachable to various image forming apparatuses. The toner storing unit includes: an electrostatic latent image bearer configured to bear an electrostatic latent image thereon; and a developing unit configured to develop the electrostatic latent image born on the electrostatic latent image bearer with the developer of the present disclosure, to form a toner image. The toner storing unit may further include other units, if necessary.

The developing unit includes: a developer container containing the developer of the present disclosure; and a developer bearer configured to bear thereon the developer contained in the developer container and convey the developer. The developing unit may further include, for example, a control member configured to control the thickness of the developer to be born.

(Image Forming Apparatus and Image Forming Method)

An image forming apparatus of the present disclosure includes an electrostatic latent image bearer, an electrostatic latent image forming unit, and a developing unit, and if necessary, may further include other units.

An image forming method relating to the present disclosure includes an electrostatic latent image forming step and a developing step. If necessary, the image forming method may further include other steps.

<Electrostatic Latent Image Bearer>

A material, structure, and size of the electrostatic latent image bearer are not particularly limited and may be appropriately selected from those publicly known. Examples of the material of the electrostatic latent image bearer include: inorganic materials, such as amorphous silicon and selenium; and organic materials, such as polysilane and phthalopolymethine. Of these, amorphous silicon is preferable from the viewpoint of long service life.

The linear speed of the electrostatic latent image bearer is preferably 300 mm/sec or higher.

<Electrostatic Latent Image Forming Unit and Electrostatic Latent Image Forming Step>

The electrostatic latent image forming unit is not particularly limited and may be appropriately selected in accordance with the intended purpose, as long as the electrostatic latent image forming unit is a unit configured to form an electrostatic latent image on the electrostatic latent image bearer. Examples of the electrostatic latent image forming unit include a unit including a charging member configured to charge a surface of the electrostatic latent image bearer and an exposing member configured to expose the surface of the electrostatic latent image bearer to light imagewise.

The electrostatic latent image forming step is not particularly limited and may be appropriately selected in accordance with the intended purpose, as long as the electrostatic latent image forming step is a step of forming an electrostatic latent image on the electrostatic latent image bearer. For example, the electrostatic latent image forming step can be performed by charging a surface of the electrostatic latent image bearer, followed by exposure of the charged surface of the electrostatic latent image bearer to light imagewise. The electrostatic latent image forming step can be performed with the electrostatic latent image forming unit.

<<Charging Member and Charging>>

The charging member is not particularly limited and may be appropriately selected in accordance with the intended purpose. Examples of the charging member include: a contact charger known per se, which is equipped with a conductive or semi-conductive roller, brush, film, or rubber blade; and a contactless charger utilizing corona discharge, such as corotron or scorotron.

For example, the charging can be performed by applying voltage to the surface of the electrostatic latent image bearer using the charging member.

The shape of the charging member may be any shape, such as a magnetic brush or a fur brush, in addition to a roller. The shape of the charging member may be selected in accordance with specifications or forms of the image forming apparatus.

The charging member is not limited to the contact charger, but the contact charger is preferable because the resulting image forming apparatus is reduced in the amount of ozone generated from the charging member.

<<Exposing Member and Exposure>>

The exposing member is not particularly limited and may be appropriately selected in accordance with the intended purpose, as long as the exposing member can imagewise expose the surface of the electrostatic latent image bearer, which has been charged with the charging member, to light corresponding to an image to be formed. Examples of the exposing member include various exposing members, such as a copy optical exposing member, a rod lens array exposing member, a laser optical exposing member, and a liquid crystal shutter optical exposing member.

A light source used for the exposing member is not particularly limited and may be appropriately selected in accordance with the intended purpose. Examples of the light source include most of light emitters, such as a fluorescent lamp, a tungsten lamp, a halogen lamp, a mercury lamp, a sodium vapor lamp, a light emitting diode (LED), a semiconductor laser (LD), and an electroluminescent light (EL).

In order to apply only the light in a desired wavelength range, various filters, such as a sharp-cut filter, a band-pass filter, a near infrared ray-cut filter, a dichroic filter, an interference filter, and a color temperature conversion filter, may also be used.

For example, the exposure may be performed by imagewise exposing the surface of the electrostatic latent image bearer to light using the exposing member.

In the present disclosure, a back-exposure system may be employed. The back-exposure system is a system in which imagewise exposure is performed from the back side of the electrostatic latent image bearer.

<Developing Unit and Developing Step>

The developing unit is not particularly limited and may be appropriately selected in accordance with the intended purpose, as long as the developing unit includes a toner and is configured to form a toner image that is a visible image obtained by developing the electrostatic latent image formed on the electrostatic latent image bearer.

The developing step is not particularly limited and may be appropriately selected in accordance with the intended purpose, as long as the developing step is a step of developing the electrostatic latent image formed on the electrostatic latent image bearer with a toner to form a toner image that is a visible image. For example, the developing step can be performed with the developing unit.

The developing unit is preferably a developing device including: a stirrer configured to stir the toner to frictionally charge the toner; and a developer bearer in which a magnetic field generating unit is fixed, where the developer bearer is configured to bear a developer including the toner on a surface thereof, and is rotatable.

<Other Units and Other Steps>

Examples of the other units include a transferring unit, a fixing unit, a cleaning unit, a charge-eliminating unit, a recycling unit, and a controlling unit.

Examples of the other steps include a transferring step, a fixing step, a cleaning step, a charge-eliminating step, a recycling step, and a controlling step.

<<Transferring Unit and Transferring Step>>

The transferring unit is not particularly limited and may be appropriately selected in accordance with the intended purpose, as long as the transferring unit is configured to transfer a visible image to a recording medium. A preferable transferring unit includes: a primary transferring unit configured to transfer visible images to an intermediate transfer member to form a composite transfer image; and a secondary transferring unit configured to transfer the composite transfer image to a recording medium.

The transferring step is not particularly limited and may be appropriately selected in accordance with the intended purpose, as long as the transferring step is a step of transferring a visible image to a recording medium. A preferable transferring step uses an intermediate transfer member, and includes primarily transferring visible images to the intermediate transfer member and then secondarily transferring the visible images to the recording medium.

For example, the transferring step can be performed by charging the photoconductor with a transfer charger to charge the visible images. The transferring step can be performed with the transferring unit.

When an image to be secondarily transferred to the recording medium is a color image formed of two or more different color toners, images of respective color toners are sequentially superimposed onto the intermediate transfer member with the transferring unit to form a composite image on the intermediate transfer member, and the composite image on the intermediate transfer member is secondarily transferred to the recording medium with the intermediate transferring unit.

The intermediate transfer member is not particularly limited and may be appropriately selected from publicly known transfer members in accordance with the intended purpose. Preferable examples of the intermediate transfer member include a transfer belt.

The transferring unit (the primary transferring unit and the secondary transferring unit) preferably includes a transferring device configured to charge the visible image formed on the photoconductor to release the visible image to the recording medium. Examples of the transferring device include a corona transferring device using corona discharge, a transfer belt, a transfer roller, a pressure transfer roller, and an adhesion transferring device.

The recording medium is typically a plane paper sheet. The recording medium is, however, not particularly limited and may be appropriately selected in accordance with the intended purpose, as long as the recording medium is a medium to which an unfixed image after development can be transferred. A PET base for OHP may also be used as the recording medium.

<<Fixing Unit and Fixing Step>>

The fixing unit is not particularly limited and may be appropriately selected in accordance with the intended purpose, as long as the fixing unit is configured to fix the transfer image transferred to the recording medium. For example, the fixing unit is preferably a publicly known heat press member. Examples of the heat press member include a combination of a heating roller and a pressing roller and a combination of a heating roller, a pressing roller, and an endless belt.

The fixing step is not particularly limited and may be appropriately selected in accordance with the intended purpose, as long as the fixing step is a step of fixing the visible image transferred to the recording medium. For example, the fixing step may be performed every time an image of each color toner is transferred to the recording medium, or may be performed once after having laminated images of respective colors toners onto the recording medium.

The fixing step may be performed with the fixing unit.

Heating with the heat press member is preferably performed at a temperature of 80° C. or higher and 200° C. or lower.

In the present disclosure, for example, a publicly known optical fixing device may be used in combination with or instead of the fixing unit in accordance with the intended purpose.

The surface pressure in the fixing step is not particularly limited and may be appropriately selected in accordance with the intended purpose. The surface pressure is preferably 10 N/cm² or higher and 80 N/cm² or lower.

<<Cleaning Unit and Cleaning Step>>

The cleaning unit is not particularly limited and may be appropriately selected in accordance with the intended purpose, as long as the cleaning unit can remove the toner remaining on the photoconductor. Examples of the cleaning unit include a magnetic brush cleaner, an electrostatic brush cleaner, a magnetic roller cleaner, a blade cleaner, a brush cleaner, and a web cleaner.

The cleaning step is not particularly limited and may be appropriately selected in accordance with the intended purpose, as long as the cleaning step is a step in which the toner remaining on the photoconductor can be removed. For example, the cleaning step can be performed with the cleaning unit.

<<Charge-Eliminating Unit and Charge-Eliminating Step>>

The charge-eliminating unit is not particularly limited and may be appropriately selected in accordance with the intended purpose, as long as the charge-eliminating unit is configured to apply charge-eliminating bias to the photoconductor to eliminate the charge of the photoconductor. Examples of the charge-eliminating unit include a charge-eliminating lamp.

The charge-eliminating step is not particularly limited and may be appropriately selected in accordance with the intended purpose, as long as the charge-eliminating step is a step of applying charge-eliminating bias to the photoconductor to eliminate the charge of the photoconductor. For example, the charge-eliminating step can be performed with the charge-eliminating unit.

<<Recycling Unit and Recycling Step>>

The recycling unit is not particularly limited and may be appropriately selected in accordance with the intended purpose, as long as the recycling unit is configured to recycle the toner removed in the cleaning step to the developing device. Examples of the recycling unit include a publicly known conveying unit.

The recycling step is not particularly limited and may be appropriately selected in accordance with the intended purpose, as long as the recycling step is a step of recycling the toner removed in the cleaning step to the developing device. For example, the recycling step may be performed with the recycling unit.

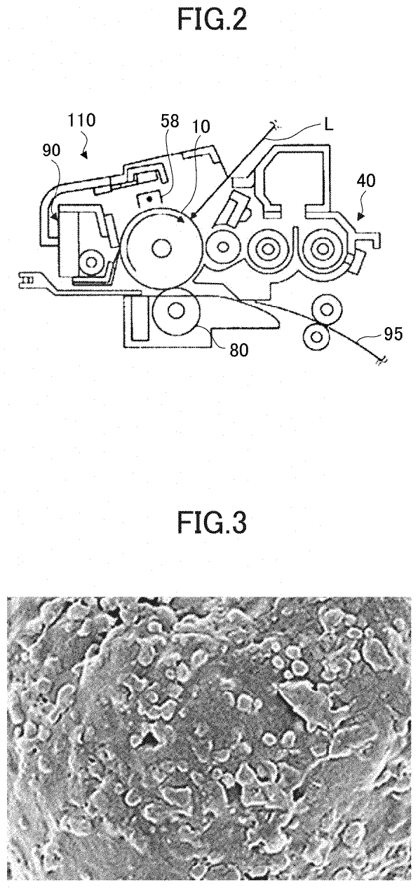

Next, one embodiment for carrying out a method of forming an image with the image forming apparatus of the present disclosure will be described with reference to FIG. 2. A printer is illustrated as an example of the image forming apparatus of the present embodiment, but the image forming apparatus is not particularly limited as long as the image forming apparatus is an apparatus capable of forming an image with a toner, such as a photocopier, a facsimile, and a multifunction peripheral.

The image forming apparatus includes a paper sheet feeding unit 210, a conveying unit 220, an image forming unit 230, a transferring unit 240, and a fixing unit 250.

The paper sheet feeding unit 210 includes: a paper sheet feeding cassette 211 loaded with paper sheets P to be fed; and a paper sheet feeding roller 212 configured to feed the paper sheets P in the paper sheet feeding cassette 211 one by one.

The conveying unit 220 includes: a roller 221 configured to feed the paper sheet P, fed with the paper sheet feeding roller 212, towards the transferring unit 240; a pair of timing rollers 222 configured to nip the leading edge of the paper sheet P, fed with the roller 221, to stand-by and send the paper sheet to the transferring unit 240 at a predetermined timing; and a paper sheet ejection roller 223 configured to eject the paper sheet P including a color toner image fixed, to the paper sheet ejection tray 224.

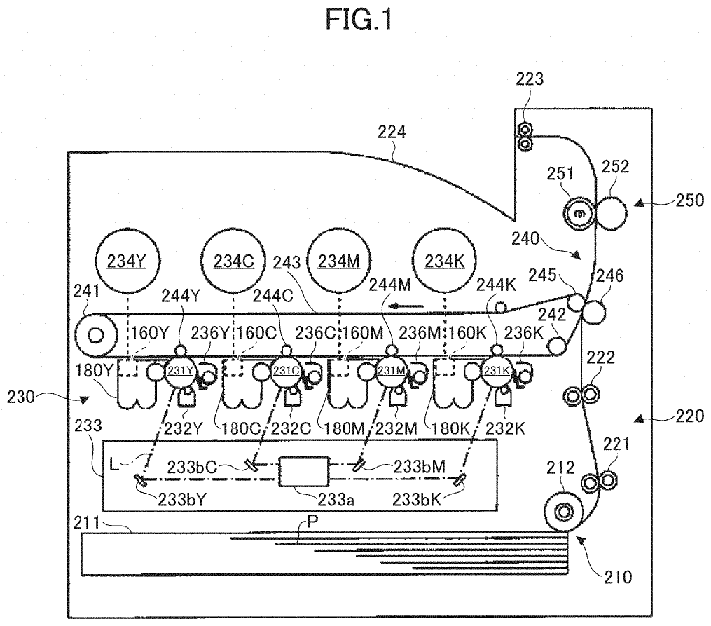

The image forming unit 230 includes: an image forming unit Y configured to form an image using a developer containing a yellow toner, an image forming unit C using a developer containing a cyan toner, an image forming unit M using a developer containing a magenta toner, and an image forming unit K using a developer containing a black toner, which are disposed in the order mentioned from left to right in FIG. 1 with predetermined gaps therebetween; and an exposing device 233.

When any image forming unit of the image forming units (Y, C, M, K) is described, it is simply referred to as an image forming unit.

The developer contains a toner and a carrier. The four image forming units (Y, C, M, K) have identical mechanical structures expect that the developer for use is different.

The transferring unit 240 includes: a driving roller 241 and a driven roller 242; an intermediate transfer belt 243 rotatable counterclockwise in FIG. 1 by the movement of the driving roller 241; primary transfer rollers (244Y, 244C, 244M, 244K) disposed to face the photoconductor drum 231 via the intermediate transfer belt 243; and a secondary counter roller 245 and a secondary transfer roller 246 that are disposed to face each other via the intermediate transfer belt 243 at the transfer position of the toner image to a paper sheet.

The fixing unit 250 includes a pressing roller 252 that includes a heater therein and is configured to rotatably press a fixing belt 251 to form a nip, where the fixing belt 251 is configured to heat the paper sheet P. The fixing unit applies heat and pressure to the color toner image on the paper sheet P to fix the color toner image. The paper sheet P on which the color toner image has been fixed is ejected to the paper sheet ejection tray 224 with the paper sheet ejection roller 223, to complete a series of image forming operations.

### EXAMPLES

The present disclosure will be described below by way of Examples. The present disclosure should not be construed as being limited to the Examples.

### Synthesis Example 1 of Non-Crystalline Resin

A four-necked flask equipped with a nitrogen-introducing tube, a water-removing tube, a stirrer, and a thermocouple was charged with a bisphenol A ethylene oxide 2 mol adduct, a bisphenol A propylene oxide 3 mol adduct, terephthalic acid, adipic acid, and trimethylolpropane so that a molar ratio of the bisphenol A ethylene oxide 2 mol adduct to the bisphenol A propylene oxide 3 mol adduct (the bisphenol A ethylene oxide 2 mol adduct/the bisphenol A propylene oxide 3 mol adduct) was to be 85/15, a molar ratio of the terephthalic acid to the adipic acid (the terephthalic acid/the adipic acid) was to be 75/25, the amount of the trimethylolpropane in the whole of the monomers was to be 1 mol %, and a molar ratio OH/COOH of a hydroxyl group to a carboxyl group was to be 1.2. In the presence of titanium tetraisopropoxide (500 ppm relative to the resin component), the resulting mixture was allowed to react under normal pressure at 230° C. for 8 hours, and the reaction mixture was further allowed to react at a reduced pressure of from 10 mmHg through 15 mmHg for 4 hours. After that, trimellitic anhydride was added to the flask so that the amount of the trimellitic anhydride was to be 1 mol % relative to the whole of the resin components, followed by reaction under normal pressure at 180° C. for 3 hours, to produce Non-crystalline polyester resin 1.

### Synthesis Example 2 of Non-Crystalline Resin

A four-necked flask equipped with a nitrogen-introducing tube, a water-removing tube, a stirrer, and a thermocouple was charged with a bisphenol A ethylene oxide 2 mol adduct, a bisphenol A propylene oxide 3 mol adduct, terephthalic acid, adipic acid, and trimethylolpropane so that a molar ratio of the bisphenol A ethylene oxide 2 mol adduct to the bisphenol A propylene oxide 3 mol adduct (the bisphenol A ethylene oxide 2 mol adduct/the bisphenol A propylene oxide 3 mol adduct) was to be 85/15, a molar ratio of the terephthalic acid to the adipic acid (the terephthalic acid/the adipic acid) was to be 85/15, the amount of the trimethylolpropane in the whole of the monomers was to be 1 mol %, and a molar ratio OH/COOH of a hydroxyl group to a carboxyl group was to be 1.04. In the presence of titanium tetraisopropoxide (500 ppm relative to the resin component), the resulting mixture was allowed to react under normal pressure at 230° C. for 8 hours, and the reaction mixture was further allowed to react at a reduced pressure of from 10 mmHg through 15 mmHg for 4 hours. After that, trimellitic anhydride was added to the flask so that the amount of the trimellitic anhydride was to be 1 mol % relative to the whole of the resin components, followed by reaction under normal pressure at 180° C. for 3 hours, to produce Non-crystalline polyester resin 2.

### Synthesis Example 3 of Non-Crystalline Resin

A four-necked flask equipped with a nitrogen-introducing tube, a water-removing tube, a stirrer, and a thermocouple was charged with a bisphenol A ethylene oxide 2 mol adduct, a bisphenol A propylene oxide 3 mol adduct, terephthalic acid, adipic acid, and trimethylolpropane so that a molar ratio of the bisphenol A ethylene oxide 2 mol adduct to the bisphenol A propylene oxide 3 mol adduct (the bisphenol A ethylene oxide 2 mol adduct/the bisphenol A propylene oxide 3 mol adduct) was to be 85/15, a molar ratio of the terephthalic acid to the adipic acid (the terephthalic acid/the adipic acid) was to be 30/70, the amount of the trimethylolpropane in the whole of the monomers was to be 1 mol %, and a molar ratio OH/COOH of a hydroxyl group to a carboxyl group was to be 1.26. In the presence of titanium tetraisopropoxide (500 ppm relative to the resin component), the resulting mixture was allowed to react under normal pressure at 230° C. for 8 hours, and the reaction mixture was further allowed to react at a reduced pressure of from 10 mmHg through 15 mmHg for 4 hours. After that, trimellitic anhydride was added to the flask so that the amount of the trimellitic anhydride was to be 1 mol % relative to the whole of the resin components, followed by reaction under normal pressure at 180° C. for 3 hours, to produce Non-crystalline polyester resin 3.

### Synthesis of Crystalline Polyester Resin

A 5 L four-necked flask equipped with a nitrogen-introducing tube, a water-removing tube, a stirrer, and a thermocouple was charged with sebacic acid and 1,6-hexanediol so that a molar ratio OH/COOH of a hydroxyl groups to a carboxyl group was to be 0.9. In the presence of titanium tetraisopropoxide (500 ppm relative to the resin components), the resulting mixture was allowed to react at 180° C. for 10 hours, then react at 200° C. for 3 hours, and then react at a pressure of 8.3 kPa for 2 hours, to produce Crystalline polyester resin 1.

### Preparation Example of Crystalline Polyester Resin Dispersion Liquid

A vessel equipped with a stirring rod and a thermometer was charged with 60 parts by mass of [Crystalline polyester resin 1] and 400 parts by mass of ethyl acetate. The resulting mixture was heated to 80° C. under stirring and kept at 80° C. for 5 hours, followed by cooling to 30° C. for 1 hour. The [Crystalline polyester resin 1] was dispersed in a bead mill (ULTRA VISCOMILL, obtained from AIMEX CO., Ltd.) under conditions in which the feeding rate was 1 kg/hr, the disc circumferential speed was 6 m/sec, zirconia beads each having a diameter of 0.5 mm were packed in an amount of 80% by volume, and the number of passes was 3, to produce Crystalline polyester resin dispersion liquid 1.

### Synthesis Example 1 of Prepolymer

A reaction vessel equipped with a condenser, a stirrer, and a nitrogen-introducing tube was charged with 3-methyl-1,5-pentanediol, isophthalic acid, adipic acid, trimellitic anhydride, and titanium tetraisopropoxide (1,000 ppm relative to the resin components) so that a molar ratio OH/COOH of a hydroxyl groups to a carboxyl group was to be 1.5, the diol component was to be formed of 100 mol % of 3-methyl-1,5-pentanediol, the dicarboxylic acid component was to be formed of 40 mol % of isophthalic acid and 60 mol % of adipic acid, and the amount of the trimellitic anhydride in the whole of the monomers was to be 1 mol %.

After that, the resulting mixture was heated to 200° C. for about 4 hours, then was heated to 230° C. for 2 hours, and was allowed to react until no flowing water was observed.

Moreover, the reaction mixture was allowed to react at a reduced pressure of from 10 mmHg through 15 mmHg for 5 hours, to produce [Intermediate polyester 1].

Next, a reaction vessel equipped with a condenser, a stirrer, and a nitrogen-introducing tube was charged with the [Intermediate polyester 1] and isophorone diisocyanate (IPDI) at a molar ratio (the isocyanate group of IPDI/the hydroxyl group of the intermediate polyester) of 2.0. The resulting mixture was diluted with ethyl acetate to be a 50% ethyl acetate solution, followed by reaction at 100° C. for 5 hours, to produce [Prepolymer 1].

### Synthesis Example 2 of Prepolymer

A reaction vessel equipped with a condenser, a stirrer, and a nitrogen-introducing tube was charged with 3-methyl-1,5-pentanediol, isophthalic acid, trimellitic anhydride, and titanium tetraisopropoxide (1,000 ppm relative to the resin components) so that a molar ratio OH/COOH of a hydroxyl groups to a carboxyl group was to be 1.5, the diol component was to be formed of 100 mol % of 3-methyl-1,5-pentanediol, the dicarboxylic acid component was to be formed of 100 mol % of isophthalic acid, and the amount of the trimellitic anhydride in the whole of the monomers was to be 1 mol %.

After that, the resulting mixture was heated to 200° C. for about 4 hours, then was heated to 230° C. for 2 hours, and was allowed to react until no flowing water was observed.

Moreover, the reaction mixture was allowed to react at a reduced pressure of from 10 mmHg through 15 mmHg for 5 hours, to produce [Intermediate polyester 2].

Next, a reaction vessel equipped with a condenser, a stirrer, and a nitrogen-introducing tube was charged with the [Intermediate polyester 2] and isophorone diisocyanate (IPDI) at a molar ratio (the isocyanate group of IPDI/the hydroxyl group of the intermediate polyester) of 2.0. The resulting mixture was diluted with ethyl acetate to be a 50% ethyl acetate solution, followed by reaction at 100° C. for 5 hours, to produce [Prepolymer 2].

### Synthesis Example 3 of Prepolymer

A reaction vessel equipped with a condenser, a stirrer, and a nitrogen-introducing tube was charged with 3-methyl-1,5-pentanediol, decane diacid, trimellitic anhydride, and titanium tetraisopropoxide (1,000 ppm relative to the resin components) so that a molar ratio OH/COOH of a hydroxyl groups to a carboxyl group was to be 1.5, the diol component was to be formed of 100 mol % of 3-methyl-1,5-pentanediol, the dicarboxylic acid component was to be formed of 100 mol % of decane diacid, and the amount of the trimellitic anhydride in the whole of the monomers was to be 1 mol %.

After that, the resulting mixture was heated to 200° C. for about 4 hours, then was heated to 230° C. for 2 hours, and was allowed to react until no flowing water was observed.

Moreover, the reaction mixture was allowed to react at a reduced pressure of from 10 mmHg through 15 mmHg for 5 hours, to produce [Intermediate polyester 3].

Next, a reaction vessel equipped with a condenser, a stirrer, and a nitrogen-introducing tube was charged with the [Intermediate polyester 3] and isophorone diisocyanate (IPDI) at a molar ratio (the isocyanate group of IPDI/the hydroxyl group of the intermediate polyester) of 2.0. The resulting mixture was diluted with ethyl acetate to be a 50% ethyl acetate solution, followed by reaction at 100° C. for 5 hours, to produce [Prepolymer 3].

### Synthesis Example 1 of Dispersion Liquid of Resin Particles

A reaction vessel equipped with a stirrer, a heating and cooling device, and a thermometer was charged with 3,710 parts by mass of water and 200 parts by mass of polyoxyethylene-1-(allyloxymethyl)alkyl ether ammonium sulfate (AQUALON KH-1025, obtained from DKS Co., Ltd.). The mixture was stirred at 200 rpm to be uniform. The resulting mixture was heated to 75° C. After addition of a mixture of 90 parts by mass of a 10% by mass ammonium persulfate aqueous solution, 450 parts by mass of styrene, 250 parts by mass of butyl acrylate, and 300 parts by mass of methacrylic acid was dripped to the resulting mixture for 4 hours.

After completion of dripping, the resulting mixture was aged at 75° C. for 4 hours, to produce [Particle dispersion liquid (W0-1)] containing resin (a1-1), which was a polymer obtained through copolymerization between the monomers and the polyoxyethylene-1-(allyloxymethyl)alkyl ether ammonium sulfate. The particles in the [Particle dispersion liquid (W0-1)] were found to have a volume average particle diameter of 15 nm, as measured through dynamic light scattering (an electrophoretic light scattering device: ELS-8000, obtained from OTSUKA ELECTRONICS CO., LTD.). Also, part of the [Particle dispersion liquid (W0-1)] was dried to isolate the resin (a1-1). The resin (a1-1) was found to have a Tg of 53° C. and an acid value of 195 mgKOH/g.

Next, a reaction vessel equipped with a stirrer, a heating and cooling device, and a thermometer was charged with 667 parts by mass of the [Particle dispersion liquid (W0-1)] and 248 parts by mass of water. After addition of 0.267 parts by mass of tert-butyl hydroperoxide (PERBUTYL H, obtained from NOF CORPORATION), the resulting mixture was heated until the temperature in the system was increased to 70° C. After that, 43.3 parts by mass of styrene, 23.3 parts by mass of butyl acrylate, and 18.0 parts by mass of a 1% by mass ascorbic acid aqueous solution were dripped to the resulting mixture for 2 hours.

After completion of dripping, the resulting mixture was aged at 70° C. for 4 hours, to produce a particle dispersion liquid of resin particles (A-1) each containing resin (a2-1) and the resin (a1-1) as constituting components thereof, where the resin (a2-1) was a polymer obtained through copolymerization of the monomers by using the resin (a1-1) in the (W0-1) as seeds. Water was added to the obtained particle dispersion liquid so that the solid content concentration of the resulting mixture was to be 20%, to produce a resin particle dispersion liquid (W-1).

The [Resin particles (A-1)] were found to have a volume average particle diameter of 17.3 nm, as measured through dynamic light scattering (an electrophoretic light scattering device: ELS-8000, obtained from OTSUKA ELECTRONICS CO., LTD.). The [Resin particle dispersion liquid (W-1)] was neutralized with a 10% by mass aqueous ammonia solution to pH 9.0, followed by centrifugation. The separated precipitate was dried and solidified, to isolate the resin (a2-1). The resin (a2-1) was found to have a Tg of 53° C. and an acid value of 195 mgKOH/g.

### Synthesis Example 2 of Dispersion Liquid of Resin Particles

A reaction vessel equipped with a stirrer, a heating and cooling device, and a thermometer was charged with 3,760 parts by mass of water and 150 parts by mass of polyoxyethylene-1-(allyloxymethyl)alkyl ether ammonium sulfate (AQUALON KH-1025, obtained from DKS Co., Ltd.). The mixture was stirred at 200 rpm to be uniform. The resulting mixture was heated to 75° C. After addition of a mixture of 90 parts by mass of a 10% by mass ammonium persulfate aqueous solution, 430 parts by mass of styrene, 270 parts by mass of butyl acrylate, and 300 parts by mass of methacrylic acid was dripped to the resulting mixture for 4 hours.

After completion of dripping, the resulting mixture was aged at 75° C. for 4 hours, to produce [Particle dispersion liquid (W0-2)] containing resin (a2-1), which was a polymer obtained through copolymerization between the monomers and the polyoxyethylene-1-(allyloxymethyl)alkyl ether ammonium sulfate. The particles in the [Particle dispersion liquid (W0-2)] were found to have a volume average particle diameter of 30 nm, as measured through dynamic light scattering (an electrophoretic light scattering device: ELS-8000, obtained from OTSUKA ELECTRONICS CO., LTD.). Also, part of the [Particle dispersion liquid (W0-2)] was dried to isolate the resin (a2-1). The resin (a2-1) was found to have a Tg of 53° C. and an acid value of 195 mgKOH/g.

Next, a reaction vessel equipped with a stirrer, a heating and cooling device, and a thermometer was charged with 667 parts by mass of the [Particle dispersion liquid (W0-2)] and 248 parts by mass of water. After addition of 0.267 parts by mass of tert-butyl hydroperoxide (PERBUTYL H, obtained from NOF CORPORATION), the resulting mixture was heated until the temperature in the system was increased to 70° C. After that, 43.3 parts by mass of styrene, 23.3 parts by mass of butyl acrylate, and 18.0 parts by mass of a 1% by mass ascorbic acid aqueous solution were dripped to the resulting mixture for 2 hours.

After completion of dripping, the resulting mixture was aged at 70° C. for 4 hours, to produce a particle dispersion liquid of resin particles (A-2) each containing resin (a2-2) and the resin (a2-1) as constituting components thereof, where the resin (a2-2) was a polymer obtained through copolymerization of the monomers by using the resin (a2-1) in the (W0-2) as seeds. Water was added to the obtained particle dispersion liquid so that the solid content concentration of the resulting mixture was to be 20%, to produce a resin particle dispersion liquid (W-2). The [Resin particles (A-2)] were found to have a volume average particle diameter of 34.3 nm, as measured through dynamic light scattering (an electrophoretic light scattering device: ELS-8000, obtained from OTSUKA ELECTRONICS CO., LTD.). The [Resin particle dispersion liquid (W-2)] was neutralized with a 10% by mass aqueous ammonia solution to pH 9.0, followed by centrifugation. The separated precipitate was dried and solidified, to isolate the resin (a2-2). The resin (a2-2) was found to have a Tg of 53° C. and an acid value of 195 mgKOH/g.

### Synthesis Example 3 of Dispersion Liquid of Resin Particles

A reaction vessel equipped with a stirrer, a heating and cooling device, and a thermometer was charged with 3,810 parts by mass of water and 100 parts by mass of polyoxyethylene-1-(allyloxymethyl)alkyl ether ammonium sulfate (AQUALON KH-1025, obtained from DKS Co., Ltd.). The mixture was stirred at 200 rpm to be uniform. The resulting mixture was heated to 75° C. After addition of a mixture of 90 parts by mass of a 10% by mass ammonium persulfate aqueous solution, 400 parts by mass of styrene, 300 parts by mass of butyl acrylate, and 300 parts by mass of methacrylic acid was dripped to the resulting mixture for 4 hours.

After completion of dripping, the resulting mixture was aged at 75° C. for 4 hours, to produce [Particle dispersion liquid (W0-3)] containing resin (a3-1), which was a polymer obtained through copolymerization between the monomers and the polyoxyethylene-1-(allyloxymethyl)alkyl ether ammonium sulfate. The particles in the [Particle dispersion liquid (W0-3)] were found to have a volume average particle diameter of 45 nm, as measured through dynamic light scattering (an electrophoretic light scattering device: ELS-8000, obtained from OTSUKA ELECTRONICS CO., LTD.). Also, part of the [Particle dispersion liquid (W0-3)] was dried to isolate the resin (a3-1). The resin (a3-1) was found to have a Tg of 53° C. and an acid value of 195 mgKOH/g.

Next, a reaction vessel equipped with a stirrer, a heating and cooling device, and a thermometer was charged with 667 parts by mass of the [Particle dispersion liquid (W0-3)] and 248 parts by mass of water. After addition of 0.267 parts by mass of tert-butyl hydroperoxide (PERBUTYL H, obtained from NOF CORPORATION), the resulting mixture was heated until the temperature in the system was increased to 70° C. After that, 43.3 parts by mass of styrene, 23.3 parts by mass of butyl acrylate, and 18.0 parts by mass of a 1% by mass ascorbic acid aqueous solution were dripped to the resulting mixture for 2 hours.

After completion of dripping, the resulting mixture was aged at 70° C. for 4 hours, to produce a particle dispersion liquid of resin particles (A-3) each containing resin (a3-2) and the resin (a3-1) as constituting components thereof, where the resin (a3-2) was a polymer obtained through copolymerization of the monomers by using the resin (a3-1) in the (W0-3) as seeds. Water was added to the obtained particle dispersion liquid so that the solid content concentration of the resulting mixture was to be 20%, to produce a resin particle dispersion liquid (W-3). The [Resin particles (A-3)] were found to have a volume average particle diameter of 51.5 nm, as measured through dynamic light scattering (an electrophoretic light scattering device: ELS-8000, obtained from OTSUKA ELECTRONICS CO., LTD.). The [Resin particle dispersion liquid (W-3)] was neutralized with a 10% by mass aqueous ammonia solution to pH 9.0, followed by centrifugation. The separated precipitate was dried and solidified, to isolate the resin (a3-2). The resin (a3-2) was found to have a Tg of 53° C. and an acid value of 195 mgKOH/g.

### Preparation Example of Wax Dispersion Liquid

A pressure-resistant reaction vessel equipped with a stirrer, a heating and cooling device, a thermometer, and a dripping cylinder was charged with 454 parts by mass of xylene and 150 parts by mass of low-molecular-weight polyethylene (SANWAX LEL-400, obtained from Sanyo Chemical Industries, Ltd.). The reaction vessel was purged with nitrogen, and then the resulting mixture was heated to 170° C. under stirring. At the same temperature, a mixture of 595 parts by mass of styrene, 255 parts by mass of methyl methacrylate, 34 parts by mass of di-t-butylperoxyhexahydro terephthalate, and 119 parts by mass of xylene was dripped to the resulting mixture for 3 hours, and the resulting mixture was further kept at the same temperature for 30 minutes. Then, the xylene was evaporated at a reduced pressure of 0.039 MPa to produce modified wax.

The graft chain of the modified wax was found to have a sp value of 10.35 (cal/cm³)^{1/2}, a Mn of 1,900, a Mw of 5200, and a Tg of 57° C.

A vessel equipped with a stirring rod and a thermometer was charged with 50 parts by mass of paraffin wax (hydrocarbon wax HNP-9, obtained from Nippon Seiro Co., Ltd., with a melting point of 75° C. and a SP value of 8.8), 5 parts by mass of the modified wax, and 165 parts by mass of ethyl acetate. The resulting mixture was heated to 80° C. under stirring and kept at 80° C. for 5 hours, followed by cooling to 30° C. for 1 hour. Then, the materials were dispersed in a bead mill (ULTRA VISCOMILL, obtained from AIMEX CO., Ltd.) under conditions in which the feeding rate was 1 kg/hr, the disc circumferential speed was 6 m/sec, zirconia beads each having a diameter of 0.5 mm were packed in an amount of 80% by volume, and the number of passes was 3, to prepare a wax dispersion liquid.

### Preparation Example 1 of Masterbatch

1,200 parts by mass of water, 500 parts by mass of carbon black (Printex35, obtained from Degussa) [DBP oil absorption: 42 mL/100 mg, pH: 9.5], and 500 parts by mass of [Non-crystalline polyester resin 1] were mixed with HENSCHEL MIXER (obtained from NIPPON COKE & ENGINEERING. CO., LTD.). After kneading of the obtained mixture for 30 minutes at 150° C. using a twin-roller kneader, the resulting product was rolled and cooled, followed by pulverization with a pulverizer, to prepare masterbatch 1.

### Preparation Example 2 of Masterbatch

100 parts by mass of montmorillonite was dispersed well in 200 mL of water, followed by addition of and mixing with 38.1 parts by mass of dimethylstearylbenzylammonium chloride (423.5 g/mol) that had been dissolved well in water. The resulting mixture was washed, dehydrated, and dried to produce an organic modified-layered inorganic mineral having an organic ion modification rate of 100%.

2,400 parts by mass of water, 1,919 parts by mass of the organic modified-layered inorganic mineral, and 1,570 parts by mass of the [Non-crystalline polyester resin 1] were mixed using HENSCHEL MIXER (obtained from NIPPON COKE & ENGINEERING. CO., LTD.). The obtained mixture kneaded with a twin-roller kneader at 150° C. for 30 minutes, followed by cooling and pulverizing with a pulverizer (obtained from HOSOKAWA MICRON CORPORATION), to prepare masterbatch 2.

### Example 1

### Preparation Example of Oil Phase

A vessel was charged with 21 parts by mass of [Wax dispersion liquid], 47 parts by mass of [Crystalline polyester dispersion liquid], 49 parts by mass of [Non-crystalline polyester resin 1] that had been prepared separately, 17 parts by mass of [Masterbatch 1], 17 parts by mass of [Masterbatch 2], and 30 parts by mass of ethyl acetate. The resulting mixture was mixed with TK HOMOMIXER (obtained from PRIMIX Corporation) at 5,000 rpm for 60 minutes. The materials were dispersed in a bead mill (ULTRA VISCOMILL, obtained from AIMEX CO., Ltd.) under conditions in which the disc circumferential speed was 7 m/sec, zirconia beads each having a diameter of 0.5 mm were packed in an amount of 70% by volume, and the number of passes (the number of passes through the bead mill per volume) was 6, to prepare [Oil phase 1]. At this time, the feeding rate was adjusted so that the whole oil phase was to be dispersed for 0.5 minutes on average per pass.

### Preparation Example of Aqueous Phase

256 parts by mass of water, 15 parts by mass of [Particle dispersion liquid (W-1)], 26 parts by mass of a 48.5% sodium dodecyldiphenyl ether disulfonate aqueous solution (ELEMINOL MON-7, obtained from SANYO CHEMICAL, LTD.), and 24 parts by mass of ethyl acetate were mixed and stirred, to prepare [Aqueous phase].

181 parts by mass of the [Oil phase], 14 parts by mass of the [Prepolymer 1], and 0.2 parts by mass of isophorone diamine as a curing agent were stirred and mixed, to prepare a mixture. 306 parts by mass of the [Aqueous phase] was added to the obtained mixture. The resulting mixture was mixed with TK HOMOMIXER at 13,000 rpm for 20 minutes. Next, the solvent was removed at 30° C. for 8 hours, followed by aging at 45° C. for 4 hours, to prepare [Dispersion slurry].

<Washing and Drying>

After filtration of 100 parts by mass of the [Dispersion slurry] under reduced pressure, the following steps were performed.

(1): To the filtration cake, 100 parts of ion-exchanged water was added. The resulting mixture was mixed with TK HOMOMIXER (at 12,000 rpm for 10 minutes), followed by filtration.

(2): To the filtration cake obtained in the above (1), a 10% sodium hydroxide aqueous solution was added until a pH of 11. The resulting mixture was mixed with TK HOMOMIXER (at 12,000 rpm for 30 minutes), followed by filtration under reduced pressure.

(3): To the filtration cake obtained in the above (2), 10% hydrochloric acid was added until a pH of from 4 through 5. The resulting mixture was mixed with TK HOMOMIXER (at 12,000 rpm for 10 minutes), followed by filtration.

(4): To the filtration cake obtained in the above (3), 300 parts by mass of ion-exchanged water was added. The resulting mixture was mixed with TK HOMOMIXER (at 12,000 rpm for 10 minutes), followed by filtration. The above steps (1) to (4) were repeated twice, to produce a filtration cake.

The filtration cake was dried with an air-circulating drier at 45° C. for 48 hours. The resulting product was passed through a sieve with a mesh size of 75 μm, to prepare toner base particles.

<External Additive Treatment>

0.6 parts by mass of hydrophobic silica having an average particle diameter of 100 nm, 1.0 part by mass of titanium oxide having an average particle diameter of 20 nm, and 0.8 parts by mass of hydrophobic silica powder having an average particle diameter of 15 nm were mixed with 100 parts by mass of [Toner base particles 1] with HENSCHEL MIXER, to produce [Toner 1]. In the obtained toner, the average circularity was found to be 0.98 and the standard deviation of the circularity was found to be 0.016.

Also, the glass transition temperature of the obtained toner was found to be 42° C. The glass transition temperature of the THF-insoluble component of the toner was found to be −37° C. The glass transition temperature of the THF-soluble component of the toner was found to be 53° C. The amount of [Resin particles (A-1)] was found to be 3.0% by mass relative to [Toner 1].

FIG. 3 is a view illustrating one example of how resin particles exist on the surface of Toner 1.

<Measurement Methods of Average Circularity and Standard Deviation of Average Circularity>

A 100 mL glass beaker was charged with 0.1 ml of a 10% by mass surfactant (alkyl benzene sulfonate, NEOGEN SC-A, obtained from DKS Co., Ltd.), 0.1 g of [Toner 1], and 80 mL of ion-exchanged water. The mixture was stirred with a micro spatula to prepare a dispersion liquid of the toner. The obtained dispersion liquid of the toner was dispersed for three minutes with an ultrasonic disperser (obtained from HONDA ELECTRONICS Co., Ltd.). The average circularity of the toner and the standard deviation of the average circularity were measured using a flow particle image analyzer (“FPIA-2100”, obtained from Sysmex Corporation) and analysis software FPIA-2100 until the concentration of the toner was from 5,000 particles/μL through 15,000 particles/μL.

<Production of Carrier>

100 parts by mass of a straight silicone resin formed only of organosiloxane bond, 5 parts by mass of γ-(2-aminoethyl)aminopropyltrimethoxysilane, and 10 parts by mass of carbon black were added to 100 parts by mass of toluene, followed by dispersing with HOMOMIXER for 20 minutes, to prepare a resin layer-coating liquid. Using a fluidized bed coating machine, the resin layer-coating liquid was coated on the surface of 1,000 parts by mass of spherical magnetite having an average particle diameter of 50 μm, to produce [Carrier].

<Production of Developer>

Using a ball mill, 5 parts by mass of [Toner 1] and 95 parts by mass of [Carrier] were mixed together, to produce a developer.

<Measurement Method of Glass Transition Temperature>

1 g of the toner was added to 100 mL of tetrahydrofuran (THF), followed by Soxhlet extraction, to produce a THF-insoluble component and a THF-soluble component from the toner. The THF-insoluble component and the THF-soluble component were dried for 24 hours with a vacuum dryer, to produce a THF-insoluble polyester resin component and a THF-soluble polyester resin component. In the following, the THF-insoluble polyester resin component was used as a sample of interest for the measurement of the glass transition temperature of the THF-insoluble component of the toner, and the THF-soluble polyester resin component was used as a sample of interest for the measurement of the glass transition temperature of the THF-soluble component of the toner. Also, the toner was used as a sample of interest for the measurement of the glass transition temperature of the toner.

Next, 5.0 mg of the sample of interest was put into a sample container of aluminum, and the sample container was placed on a holder unit and set in an electric furnace.

Next, in a nitrogen atmosphere, the sample of interest was heated from −80° C. to 150° C. at a heating rate of 1.0° C./min (the first heating).

Next, the sample of interest was cooled from 150° C. to −80° C. at a cooling rate of 1.0° C./min and then heated from −80° C. to 150° C. at a heating rate of 1.0° C./min (the second heating).

At the first heating and the second heating, DSC curves were measured with a differential scanning calorimeter (Q-200, obtained from TA Instruments). Using the analysis program in the Q-200 system, the glass transition temperature Tg1^{st} at the first heating was determined by selecting the DSC curve at the first heating from the obtained DSC curves. Similarly, the glass transition temperature Tg2^{nd} at the second heating was determined by selecting the DSC curve at the second heating.

### Example 2

[Toner 2] was produced in the same manner as in Example 1 except that [Particle dispersion liquid (W-1)] in the preparation of the aqueous phase was changed to [Particle dispersion liquid (W-2)]. [Toner 2] was measured for the average circularity and the standard deviation of the average circularity in the same manner as in Example 1. The average circularity of [Toner 2] was found to be 0.98 and the standard deviation of the average circularity was found to be 0.016.

Also, the glass transition temperature of [Toner 2] was found to be 42° C., the glass transition temperature of the THF-insoluble component of [Toner 2] was found to be −37° C., the glass transition temperature of the THF-soluble component of [Toner 2] was found to be 53° C., and the amount of [Resin particles (A-2)] was found to be 3.0% by mass relative to [Toner 2].

### Example 3

[Toner 3] was produced in the same manner as in Example 1 except that [Particle dispersion liquid (W-1)] in the preparation of the aqueous phase was changed to [Particle dispersion liquid (W-3)]. [Toner 3] was measured for the average circularity and the standard deviation of the average circularity in the same manner as in Example 1. The average circularity of [Toner 3] was found to be 0.98 and the standard deviation of the average circularity was found to be 0.016.

Also, the glass transition temperature of [Toner 3] was found to be 42° C., the glass transition temperature of the THF-insoluble component of [Toner 3] was found to be −37° C., the glass transition temperature of the THF-soluble component of [Toner 3] was found to be 53° C., and the amount of [Resin particles (A-3)] was found to be 3.0% by mass relative to [Toner 3].

### Example 4

[Toner 4] was produced in the same manner as in Example 1 except that the disc circumferential speed of the bead mill in the preparation of the oil phase was changed to 9 m/sec. [Toner 4] was measured for the average circularity and the standard deviation of the average circularity in the same manner as in Example 1. The average circularity of [Toner 4] was found to be 0.972 and the standard deviation of the average circularity was found to be 0.017.

Also, the glass transition temperature of [Toner 4] was found to be 42° C., the glass transition temperature of the THF-insoluble component of [Toner 4] was found to be −37° C., the glass transition temperature of the THF-soluble component of [Toner 4] was found to be 53° C., and the amount of [Resin particles (A-1)] was found to be 3.0% by mass relative to [Toner 4].

### Example 5

[Toner 5] was produced in the same manner as in Example 1 except that in the preparation of the oil phase, the disc circumferential speed of the bead mill was changed to 7 m/sec and the number of passes (the number of passes through the bead mill per volume) was changed to 10. [Toner 5] was measured for the average circularity and the standard deviation of the average circularity in the same manner as in Example 1. The average circularity of [Toner 5] was found to be 0.976 and the standard deviation of the average circularity was found to be 0.014.

Also, the glass transition temperature of [Toner 5] was found to be 42° C., the glass transition temperature of the THF-insoluble component of [Toner 5] was found to be −37° C., the glass transition temperature of the THF-soluble component of [Toner 5] was found to be 53° C., and the amount of [Resin particles (A-1)] was found to be 3.0% by mass relative to [Toner 5].

### Example 6

[Toner 6] was produced in the same manner as in Example 1 except that the disc circumferential speed of the bead mill in the preparation of the oil phase was changed to 6 m/sec. [Toner 6] was measured for the average circularity and the standard deviation of the average circularity in the same manner as in Example 1. The average circularity of [Toner 6] was found to be 0.983 and the standard deviation of the average circularity was found to be 0.019.

Also, the glass transition temperature of [Toner 6] was found to be 42° C., the glass transition temperature of the THF-insoluble component of [Toner 6] was found to be −37° C., the glass transition temperature of the THF-soluble component of [Toner 6] was found to be 53° C., and the amount of [Resin particles (A-1)] was found to be 3.0% by mass relative to [Toner 6].

### Example 7

[Toner 7] was produced in the same manner as in Example 1 except that in the washing and the drying, 300 parts by mass of ion-exchanged water was added to the filtration cake, followed by mixing with TK HOMOMIXER (at 12,000 rpm for 10 minutes), and the resulting mixture was heated to 68° C. using a plate-type heat exchanger and retained for 20 minutes, followed by cooling to 25° C. using a plate-type heat exchanger. [Toner 7] was measured for the average circularity and the standard deviation of the average circularity in the same manner as in Example 1. The average circularity of [Toner 7] was found to be 0.982 and the standard deviation of the average circularity was found to be 0.016.

Also, the glass transition temperature of [Toner 7] was found to be 42° C., the glass transition temperature of the THF-insoluble component of [Toner 7] was found to be −37° C., the glass transition temperature of the THF-soluble component of [Toner 7] was found to be 53° C., and the amount of [Resin particles (A-1)] was found to be 3.0% by mass relative to [Toner 7].

### Example 8

[Toner 8] was produced in the same manner as in Example 1 except that the amount of [Particle dispersion liquid (W-1)] in the preparation of the aqueous phase was changed to 21 parts by mass. [Toner 8] was measured for the average circularity and the standard deviation of the average circularity in the same manner as in Example 1. The average circularity of [Toner 8] was found to be 0.981 and the standard deviation of the average circularity was found to be 0.019.

Also, the glass transition temperature of [Toner 8] was found to be 42° C., the glass transition temperature of the THF-insoluble component of [Toner 8] was found to be −37° C., the glass transition temperature of the THF-soluble component of [Toner 8] was found to be 53° C., and the amount of [Resin particles (A-1)] was found to be 4.1% by mass relative to [Toner 8].

### Comparative Example 1

[Toner 9] was produced in the same manner as in Example 1 except that the treatment with the bead mill in the preparation of the oil phase was not performed. [Toner 9] was measured for the average circularity and the standard deviation of the average circularity in the same manner as in Example 1. The average circularity of [Toner 9] was found to be 0.982 and the standard deviation of the average circularity was found to be 0.026.

Also, the glass transition temperature of [Toner 9] was found to be 42° C., the glass transition temperature of the THF-insoluble component of [Toner 9] was found to be −37° C., the glass transition temperature of the THF-soluble component of [Toner 9] was found to be 53° C., and the amount of [Resin particles (A-1)] was found to be 3.0% by mass relative to [Toner 9].

### Comparative Example 2

[Toner 10] was produced in the same manner as in Example 1 except that the treatment with the bead mill in the preparation of the oil phase was not performed, and that in the washing and the drying, 300 parts by mass of ion-exchanged water was added to the filtration cake, followed by mixing with TK HOMOMIXER (at 12,000 rpm for 10 minutes), and the resulting mixture was heated to 75° C. using a plate-type heat exchanger and retained for 80 minutes, followed by cooling to 25° C. using a plate-type heat exchanger. [Toner 10] was measured for the average circularity and the standard deviation of the average circularity in the same manner as in Example 1. The average circularity of [Toner 10] was found to be 0.986 and the standard deviation of the average circularity was found to be 0.019.

Also, the glass transition temperature of [Toner 10] was found to be 42° C., the glass transition temperature of the THF-insoluble component of [Toner 10] was found to be −37° C., the glass transition temperature of the THF-soluble component of [Toner 10] was found to be 53° C., and the amount of [Resin particles (A-1)] was found to be 3.0% by mass relative to [Toner 10].

### Comparative Example 3

[Toner 11] was produced in the same manner as in Example 1 except that in the preparation of the oil phase, the disc circumferential speed of the bead mill was changed to 9 m/sec and the number of passes (the number of passes through the bead mill per volume) was changed to 30. [Toner 11] was measured for the average circularity and the standard deviation of the average circularity in the same manner as in Example 1. The average circularity of [Toner 11] was found to be 0.968 and the standard deviation of the average circularity was found to be 0.018.

Also, the glass transition temperature of [Toner 11] was found to be 42° C., the glass transition temperature of the THF-insoluble component of [Toner 11] was found to be −37° C., the glass transition temperature of the THF-soluble component of [Toner 11] was found to be 53° C., and the amount of [Resin particles (A-1)] was found to be 3.0% by mass relative to [Toner 11].

### Comparative Example 4

[Toner 12] was produced in the same manner as in Example 1 except that [Non-crystalline polyester 1] was changed to [Non-crystalline polyester 2]. [Toner 12] was measured for the average circularity and the standard deviation of the average circularity in the same manner as in Example 1. The average circularity of [Toner 12] was found to be 0.981 and the standard deviation of the average circularity was found to be 0.016.

Also, the glass transition temperature of [Toner 12] was found to be 55° C., the glass transition temperature of the THF-insoluble component of [Toner 12] was found to be −37° C., and the amount of [Resin particles (A-1)] was found to be 3.0% by mass relative to [Toner 12].

### Comparative Example 5

[Toner 13] was produced in the same manner as in Example 1 except that [Non-crystalline polyester 1] was changed to [Non-crystalline polyester 3] and that 14 parts by mass of [Prepolymer 1] was changed to 21 parts by mass of [Prepolymer 1]. [Toner 13] was measured for the average circularity and the standard deviation of the average circularity in the same manner as in Example 1. The average circularity of [Toner 13] was found to be 0.980 and the standard deviation of the average circularity was found to be 0.016.

Also, the glass transition temperature of [Toner 13] was found to be 18° C., the glass transition temperature of the THF-insoluble component of [Toner 13] was found to be −39° C., and the amount of [Resin particles (A-1)] was found to be 3.0% by mass relative to [Toner 13].

### Comparative Example 6

[Toner 14] was produced in the same manner as in Example 1 except that 14 parts by mass of [Prepolymer 1] was changed to 7 parts by mass of [Prepolymer 2]. [Toner 14] was measured for the average circularity and the standard deviation of the average circularity in the same manner as in Example 1. The average circularity of [Toner 14] was found to be 0.980 and the standard deviation of the average circularity was found to be 0.016.

Also, the glass transition temperature of [Toner 14] was found to be 48° C., the glass transition temperature of the THF-insoluble component of [Toner 14] was found to be 13° C., and the amount of [Resin particles (A-1)] was found to be 3.0% by mass relative to [Toner 14].

### Comparative Example 7

[Toner 15] was produced in the same manner as in Example 1 except that [Prepolymer 1] was changed to [Prepolymer 3]. [Toner 15] was measured for the average circularity and the standard deviation of the average circularity in the same manner as in Example 1. The average circularity of [Toner 15] was found to be 0.981 and the standard deviation of the average circularity was found to be 0.016.

Also, the glass transition temperature of [Toner 15] was found to be 35° C., the glass transition temperature of the THF-insoluble component of [Toner 15] was found to be −55° C., and the amount of [Resin particles (A-1)] was found to be 3.0% by mass relative to [Toner 15].

The toners obtained in Examples 1 to 8 and Comparative Examples 1 to 7 were evaluated for low-temperature fixability, heat-resistant storage stability, cleanability, and transferability. The evaluation results are presented in Table 1 to Table 3 below.

<Low-Temperature Fixability>

Using a color multifunction peripheral (IMAGIO MP C4500, obtained from Ricoh Company, Ltd.) from which a thermal fixing device had been removed, the toner was uniformly placed on a paper sheet (Recycled PPC Paper 100, obtained from Oji Paper Co., Ltd.) so as to be 0.8 mg/cm².

The minimum fixable temperature when the above paper sheet was passed through a nip with the pressing roller at a fixing speed (a circumferential speed of the heating roller) of 213 mm/sec and a fixing pressure (a pressing roller pressure) of 10 kg/cm². The minimum fixable temperature was evaluated according to the following evaluation criteria.

[Evaluation Criteria]

A: The minimum fixable temperature was 130° C. or lower.

B: The minimum fixable temperature was higher than 130° C. and 135° C. or lower.

C: The minimum fixable temperature was higher than 135° C. and 140° C. or lower.

D: The minimum fixable temperature was higher than 140° C.

<Heat-Resistant Storage Stability>

A 50 mL glass container was charged with 10 g of the toner. After stored at 50° C. for 8 hours, the toner was passed through a 42-mesh sieve for 2 minutes, and the mass of the toner remaining on the wire mesh (sieve) was measured. The residual rate of the toner was measured from the ratio of the mass of the remaining toner to the mass of the toner put into the sieve; i.e., [(the mass of the toner remaining on the wire mesh/the mass of the toner put into the sieve)×100]. The heat-resistant storage stability was evaluated according to the following evaluation criteria.

[Evaluation Criteria]

A: The residual rate was lower than 5%.

B: The residual rate was 5% or higher and lower than 15%.

C: The residual rate was 15% or higher and lower than 30%.

D: The residual rate was 30% or higher.

<Cleanability>

In a laboratory environment of 21° C. and 65% RH, the above image forming apparatus was used to output 50,000 charts (A4 size, landscape orientation) each having an image area ratio of 5% at 3 prints/job.

After that, in a laboratory environment of 32° C. and 54% RH, 100 of 3 charts (A4 size, landscape orientation) each having a 43 mm-wide longitudinal band pattern (relative to the paper sheet feeding direction) as an evaluation image were output. The obtained images were visually observed to evaluate cleanability of the toner according to the following evaluation criteria.

[Evaluation Criteria]

A: Any toner particles that passed through due to cleaning failure were not visually observed on the printed paper sheet or on the photoconductor, and even when the photoconductor was microscopically observed in the longer direction thereof, any streaks of the toner particles that passed through were not observed.

B: Toner particles that passed through due to cleaning failure were not visually observed on the printed paper sheet or on the photoconductor.

D: Toner particles that passed through due to cleaning failure were visually observed both on the printed paper sheet and the photoconductor.

<Transferability>

DocuColor 8000 Digital Press obtained from FUJIFILM Business Innovation Corp. was modified and tuned so that the linear velocity was 162 mm/sec and the transfer duration was 40 msec. Using the resulting evaluating machine, each of the developers was subjected to a running test of outputting, as a test image, a A4-size solid pattern having a toner deposition amount of 0.6 mg/cm². After output of 100 K test images, the primary transfer efficiency in primary transfer was determined from Formula (3) below, and the secondary transfer efficiency in secondary transfer was determined from Formula (4) below. The average value of the primary transfer efficiency and the secondary transfer efficiency was calculated and was evaluated for transferability according to the following evaluation criteria.

Primary transfer efficiency(%)=(Amount of the toner transferred to an intermediate transfer member/Amount of the toner developed on an electrophotographic photoconductor)×100 Formula (3)

Secondary transfer efficiency(%)=(Amount of the toner transferred to an intermediate transfer member−Amount of the toner remaining after transfer on the intermediate transfer member/Amount of the toner transferred to an intermediate transfer member)×100 Formula (4)

[Evaluation Criteria]

A: 90% or more

B: 85% or more and less than 90%

C: 80% or more and less than 85%

D: Less than 80%

TABLE 1

| | | Ex. 1 | Ex. 2 | Ex. 3 | Ex. 4 | Ex. 5 |
|---|---|---|---|---|---|---|
| Toner No. | | 1 | 2 | 3 | 4 | 5 |
| Average circularity | | 0.98 | 0.98 | 0.98 | 0.972 | 0.976 |
| Standard deviation | | 0.016 | 0.016 | 0.016 | 0.017 | 0.014 |
| of average circularity | | | | | | |
| Glass transition | | 42 | 42 | 42 | 42 | 42 |
| temperature (° C.) | | | | | | |
| of the toner | | | | | | |
| Glass transition | | −37 | −37 | −37 | −37 | −37 |
| temperature (° C.) | | | | | | |
| of THF-insoluble | | | | | | |
| component of the toner | | | | | | |
| Evaluation | Low- | A | A | B | A | A |
| results | temperature | | | | | |
| | fixability | | | | | |
| | Heat- | B | A | A | A | A |
| | resistant | | | | | |
| | storage | | | | | |
| | stability | | | | | |
| | Cleanability | B | B | B | A | A |
| | Transfer- | A | A | A | B | B |
| | ability | | | | | |

TABLE 2

| | | | | | Comp. | Comp. | Comp. |
|---|---|---|---|---|---|---|---|
| | | Ex. 6 | Ex. 7 | Ex. 8 | Ex. 1 | Ex. 2 | Ex. 3 |
| Toner No. | | 6 | 7 | 8 | 9 | 10 | 11 |
| Average circularity | | 0.983 | 0.982 | 0.981 | 0.982 | 0.986 | 0.968 |
| Standard deviation of | | 0.019 | 0.016 | 0.019 | 0.026 | 0.019 | 0.018 |
| average circularity | | | | | | | |
| Glass transition | | 42 | 42 | 42 | 42 | 42 | 42 |
| temperature (° C.) of the | | | | | | | |
| toner | | | | | | | |
| Glass transition | | −37 | −37 | −37 | −37 | −37 | −37 |
| temperature (° C.) of THF- | | | | | | | |
| insoluble component of the toner | | | | | | | |
| Evaluation | Low-temperature | A | A | B | B | A | B |
| results | fixability | | | | | | |
| | Heat-resistant | B | A | A | D | B | D |
| | storage stability | | | | | | |
| | Cleanability | B | A | A | D | D | A |
| | Transferability | A | A | B | A | A | D |

TABLE 3

| | | Comp . | Comp . | Comp . | Comp . |
|---|---|---|---|---|---|
| | | Ex. 4 | Ex. 5 | Ex. 6 | Ex. 7 |
| Toner No. | | 12 | 13 | 14 | 15 |
| Average circularity | | 0.981 | 0.980 | 0.980 | 0.981 |
| Standard deviation of | | 0.016 | 0.016 | 0.016 | 0.016 |
| average circularity | | | | | |
| Glass transition | | 55 | 18 | 48 | 35 |
| temperature (° C.) of the | | | | | |
| toner | | | | | |
| Glass transition | | −37 | −39 | 13 | −55 |
| temperature (° C.) of THF- | | | | | |
| insoluble component of the | | | | | |
| toner | | | | | |
| Evaluation | Low-temperature | D | A | D | A |
| results | fixability | | | | |
| | Heat-resistant | B | D | A | D |
| | storage | | | | |
| | stability | | | | |
| | Cleanability | B | B | B | B |
| | Transferability | A | A | A | A |

The toners of Examples 1 to 8 of the present disclosure exhibited excellent properties of all of low-temperature fixability, heat-resistant storage stability, cleanability, and transferability. In contrast to this, none of the toners of Comparative Examples 1 to 7 exhibited excellent properties for all of the following evaluation criteria: low-temperature fixability, heat-resistant storage stability, cleanability, and transferability.

Aspects and embodiments of the present disclosure are as follows, for example.

<1> A toner, including:

toner base particles each containing a binder resin; and

resin particles on a surface of each of the toner base particles, wherein:

a glass transition temperature (Tg) of the toner at first heating in differential scanning calorimetry (DSC) is 20° C. or higher and 50° C. or lower;

a glass transition temperature (Tg) of a tetrahydrofuran (THF)-insoluble component of the toner at first heating in DSC is −40° C. or higher and 10° C. or lower;

an average circularity of the toner is 0.970 or more and 0.985 or less; and

a standard deviation of the average circularity is 0.020 or less.

<2> The toner according to <1> above, wherein the standard deviation of the average circularity is 0.014 or less.

<3> The toner according to <1> or <2> above, wherein:

the glass transition temperature (Tg) of the toner at first heating in differential scanning calorimetry (DSC) is 40° C. or higher and 50° C. or lower;

the glass transition temperature (Tg) of the THF-insoluble component of the toner at first heating in DSC is −40° C. or higher and 5° C. or lower; and

a glass transition temperature (Tg) of the THF-soluble component of the toner at second heating in DSC is 20° C. or higher and 65° C. or lower.

<4> The toner according to any one of <1> to <3> above, wherein an amount of the resin particles is 0.2% by mass or more and 5% by mass or less relative to the toner.

<5> The toner according to any one of <1> to <4> above, wherein:

the binder resin is a polyester resin; and

the polyester resin includes a trivalent or tetravalent aliphatic multivalent alcohol component having 3 or more and 10 or less carbon atoms.

<6> The toner according to <5> above, wherein:

the polyester resin includes a diol component; and

the diol component includes:
a portion to be a main chain thereof, where the portion has 3 or more and 9 or less carbon atoms; and
an alkyl group in a side chain thereof.

<7> The toner according to <5> or <6> above, wherein the polyester resin includes a urethane bond or a urea bond, or both.

<8> A toner storing unit, including:

the toner according to any one of <1> to <7> above, the toner being stored in the toner storing unit.

<9> An image forming apparatus, including:

the toner storing unit according to <8> above.

<10> An image forming apparatus, including:

an electrostatic latent image bearer;

an electrostatic latent image forming unit configured to form an electrostatic latent image on the electrostatic latent image bearer; and

a developing unit that includes the toner according to any one of <1> to <7> above and is configured to develop the electrostatic latent image with the toner to form a visible image.

The toner according to any one of <1> to <7> above, the toner storing unit according to <8> above, and the image forming apparatus according to <9> or <10> above can solve the various problems pertinent in the art and achieve the object of the present disclosure.

Further, the present invention is not limited to these embodiments, but various variations and modifications may be made without departing from the scope of the present invention.

What is claimed is:

1. A toner, comprising:
toner base particles each containing a binder resin; and
resin particles on a surface of each of the toner base particles, wherein:
a glass transition temperature (Tg) of the toner at first heating in differential scanning calorimetry (DSC) is 20° C. or higher and 50° C. or lower;
a glass transition temperature (Tg) of a tetrahydrofuran (THF)-insoluble component of the toner at first heating in DSC is −40° C. or higher and 10° C. or lower;
an average circularity of the toner is 0.970 or more and 0.985 or less; and
a standard deviation of the average circularity is 0.020 or less.

2. The toner according to claim 1, wherein the standard deviation of the average circularity is 0.014 or less.

3. The toner according to claim 1, wherein:
the glass transition temperature (Tg) of the toner at first heating in differential scanning calorimetry (DSC) is 40° C. or higher and 50° C. or lower;
the glass transition temperature (Tg) of the THF-insoluble component of the toner at first heating in DSC is −40° C. or higher and 5° C. or lower; and
a glass transition temperature (Tg) of the THF-soluble component of the toner at second heating in DSC is 20° C. or higher and 65° C. or lower.

4. The toner according to claim 1, wherein an amount of the resin particles is 0.2% by mass or more and 5% by mass or less relative to the toner.

5. The toner according to claim 1, wherein:
the binder resin is a polyester resin; and
the polyester resin includes a trivalent or tetravalent aliphatic multivalent alcohol component having 3 or more and 10 or less carbon atoms.

6. The toner according to claim 5, wherein:
the polyester resin includes a diol component; and
the diol component includes:
a portion to be a main chain thereof, where the portion has 3 or more and 9 or less carbon atoms; and
an alkyl group in a side chain thereof.

7. The toner according to claim 5,
wherein the polyester resin includes a urethane bond or a urea bond, or both.

8. A toner storing unit, comprising:
the toner according to claim 1, the toner being stored in the toner storing unit.

9. An image forming apparatus, comprising:
the toner storing unit according to claim 8.

10. An image forming apparatus, comprising:
an electrostatic latent image bearer;
an electrostatic latent image forming unit configured to form an electrostatic latent image on the electrostatic latent image bearer; and
a developing unit that includes the toner according to claim 1 and is configured to develop the electrostatic latent image with the toner to form a visible image.
